(19) United States
(12) Patent Application Publication
(10) Pub. No.: US 2026/0228862 A1
(43) Pub. Date: Aug. 6, 2026

(54) AREA-BASED ANTI-ALIASING FOR CGI WITH 4, 8, 16 OR 32 SUBPIXELS

(71) Applicant: Michel Alexandre Rohner, SAN JOSE, CA (US)

(72) Inventor: Michel Alexandre Rohner, SAN JOSE, CA (US)

(21) Appl. No.: 19/044,495

(22) Filed: Feb. 3, 2025

(51) Int. Cl. G06T 5/70

(52) U.S. Cl. CPC G06T 5/70; G06T 2200/12

(57) ABSTRACT

The purpose of anti-aliasing is to reduce distracting aliasing artifacts in Computer Generated Imagery (CGI). The most common approach for CGI consists of processing objects in scenes made of triangles defined in a 3D space, followed by projection and rendering on a 2D image plane.

When images are rendered using a single sample point per pixel, they can achieve the fastest processing time, at the expense of aliasing artifacts, or “jaggies”. These most noticeable artifacts are “stairsteps” and “narrow faces breakup”. The current solutions rely on multiple point sampling, or single point sampling followed by postprocessing. Their main problem is reduced frame rate due to increased processing time. Also, they cannot correct narrow faces breakup for all edge orientations.

A new approach, area-based anti-aliasing (ABAA) relies on subpixel area-sampling instead of point-sampling. It is the fastest and produces the best static and moving images with AA.

The present invention relates to computers methods in the field of Computer-Generated Imagery (CGI). CGI consists of computer applications for creating images in art, printed media, video games, simulators and computer animation. When 2D-images computed using single point sampling, they can achieve the fastest frame rate, at the expense of aliasing artifacts. The most noticeable artifacts are “stairsteps” and “narrow faces breakup”.

The purpose of anti-aliasing (AA) is to reduce, if not eliminate, these distracting aliasing artifacts. The problem with most anti-aliasing current solutions is the increased processing time and reduced frame rate. Currently available AA solutions rely on multiple point sampling, or single point sampling followed by postprocessing. However, they have limited success at reducing processing time and correcting narrow faces breakup. Also, their performances depend on edge orientation.

This following invention describes a new AA approach, area-based anti-aliasing (ABAA) that relies on subpixel area-sampling instead of point-sampling. It is the fastest and produces the best static and moving images with AA.

The present invention is intended for fast processing in HW, although it can be implemented in SW to optimize program execution.

### 1. BACKGROUND ART

### Brief Description of the Drawings

Fig. Error! No text of specified style in document.A shows the Gaming Area and the coordinate systems in the 3D database.

Fig. Error! No text of specified style in document.B shows 3 triangle representations with triangle, strip and fan.

FIG. 1C shows a block diagram of the triangle processing pipeline with concurrent processing of Frames 0, 1, 2 and 3.

Fig. Error! No text of specified style in document.D illustrates the translation from object coordinates into data base coordinates.

FIG. 1E shows how a translated vertex Vt is rotated into a window vertex Vw, in 2 steps. The translated vertex Vt is rotated into in aircraft coordinates Va with attitude matrix Ha, Then Va is rotated and scaled into a vertex Vw in window coordinates, with a window matrix Hw.

FIG. 1F shows how the Clipping operation removes portions of triangles outside of the field of view.

FIG. 1G illustrates the projection from 3D to 2D.

Fig. Error! No text of specified style in document.H shows the projected triangle in 2D image coordinate system.

Fig. Error! No text of specified style in document.I shows the display area for an image of size PixMax pixels by SLMax scanlines.

Fig. Error! No text of specified style in document.J shows how the integer (Pix, SL) image coordinates relate to the projected fixed-point projection (x, y) coordinates.

FIG. 1K shows how a moving triangle is mapped on the image, using 1 sample point per pixel.

FIG. 1L shows how faces narrower than 1 pixel wide can cause “narrow face breakup”.

### BASIC CGI OPERATIONS

### 3D Objects Defined in Gaming Area

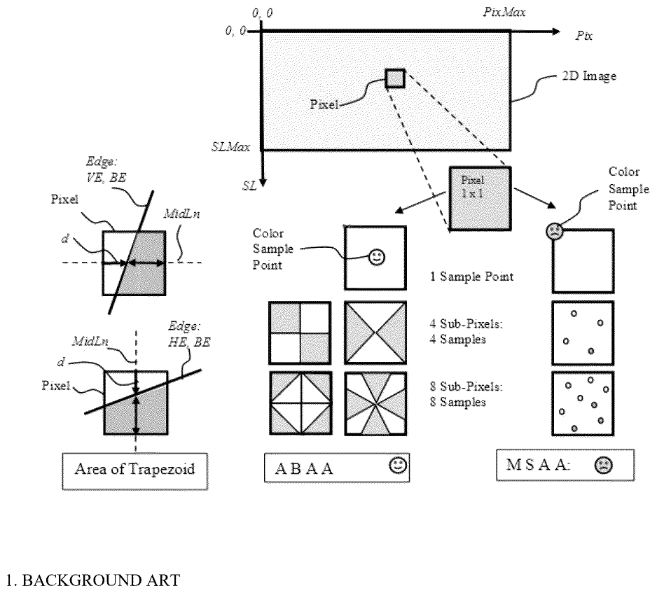

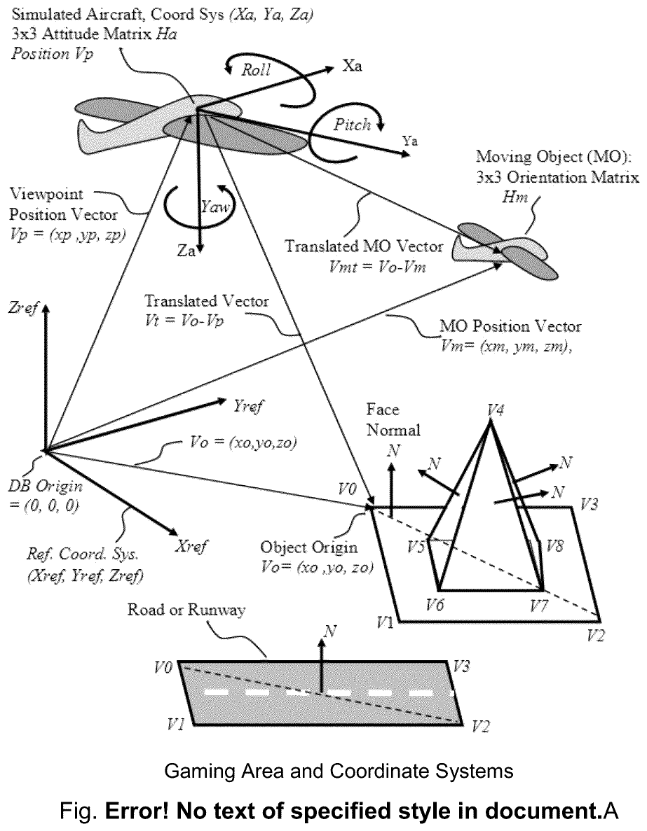

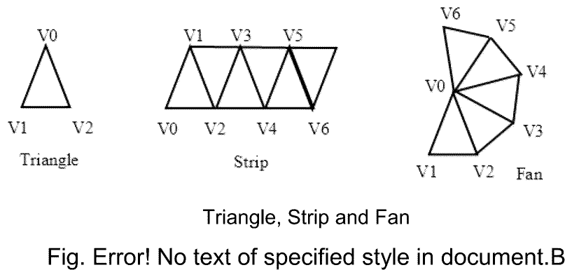

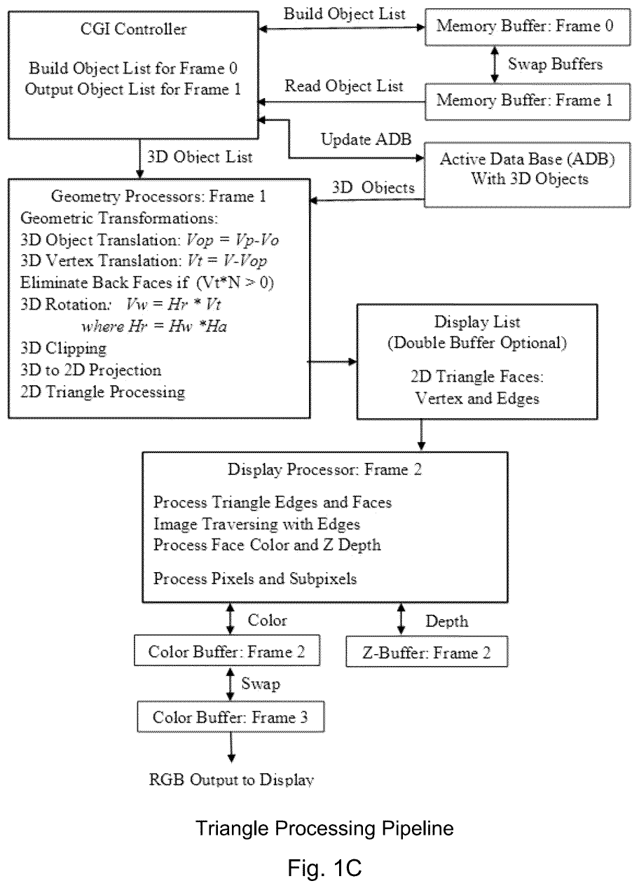

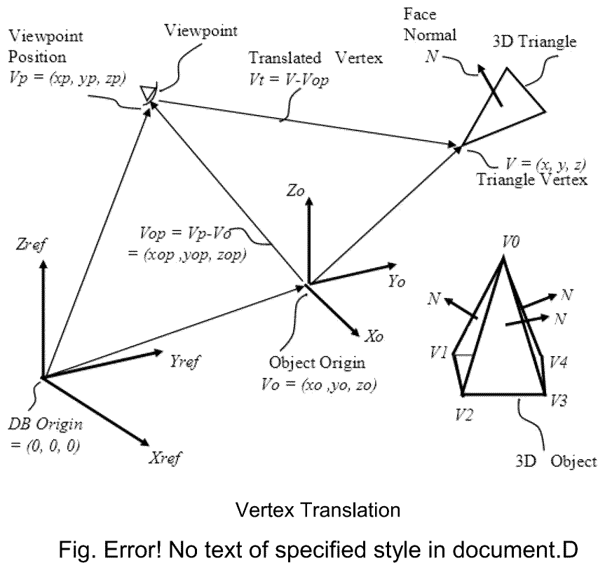

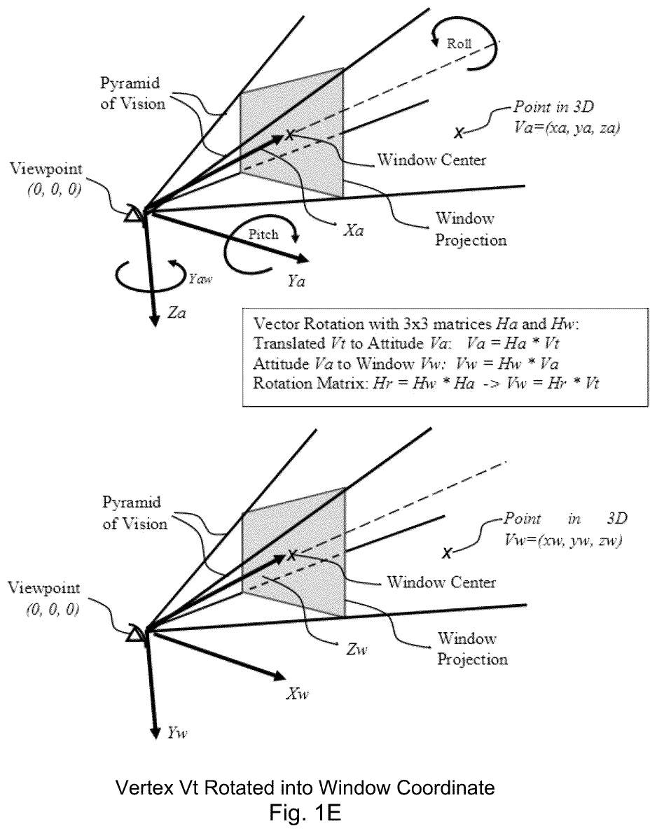

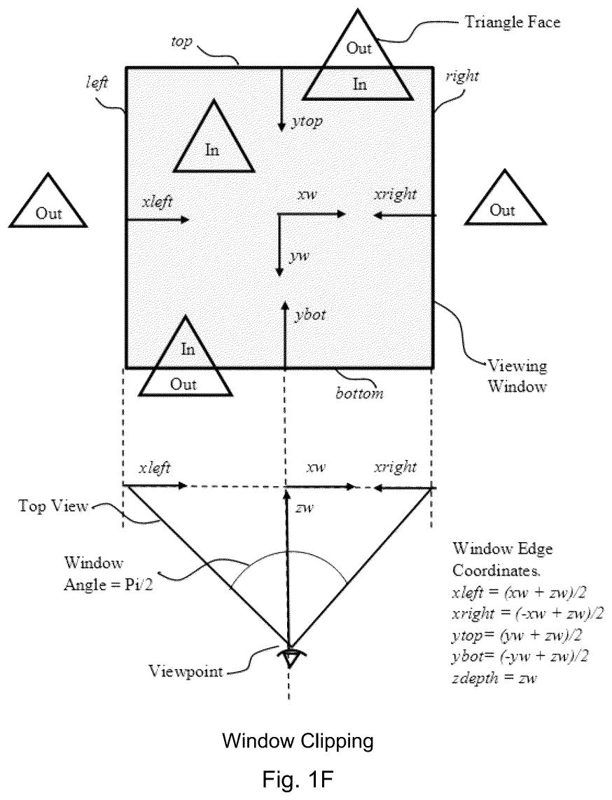

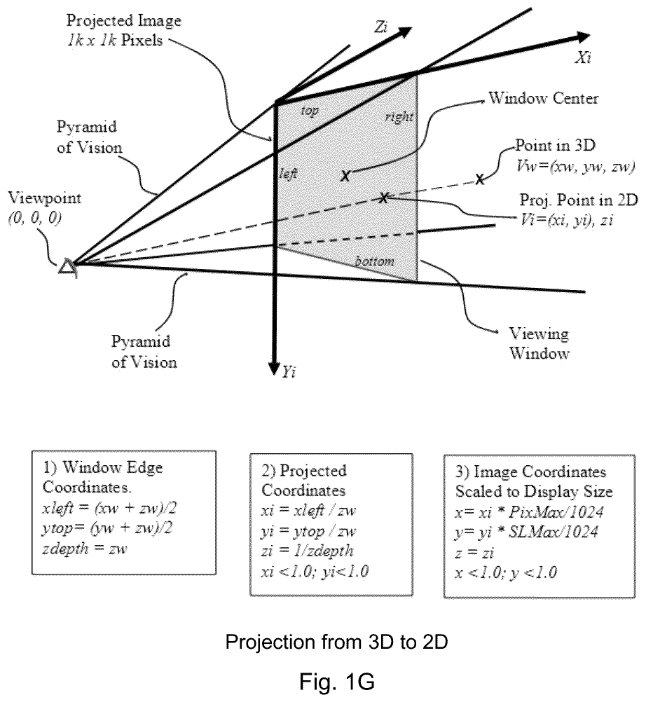

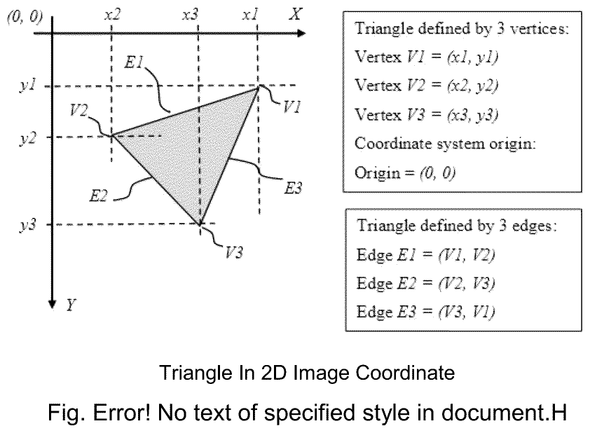

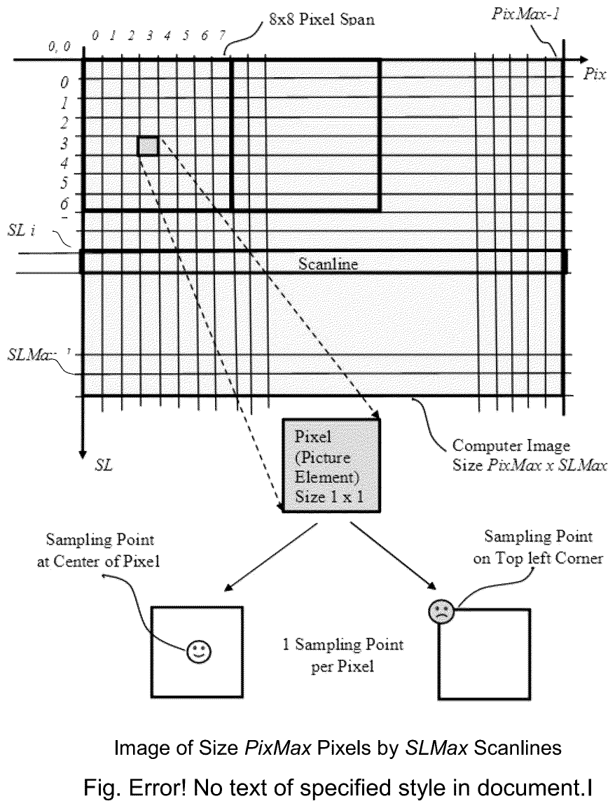

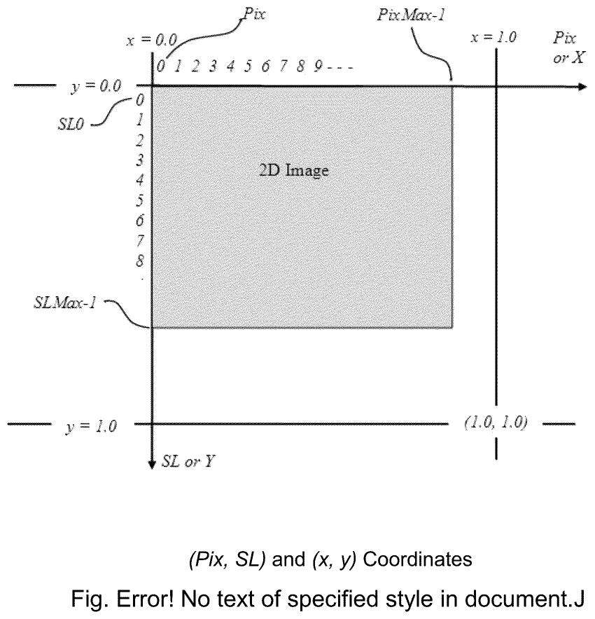

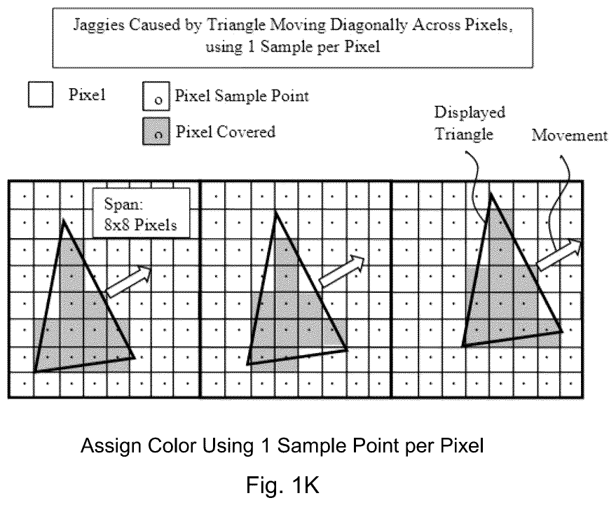

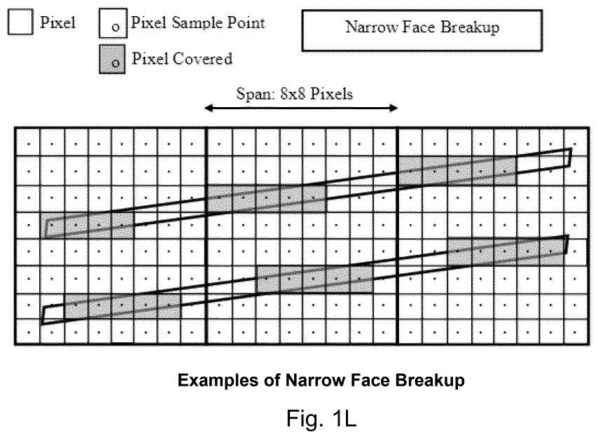

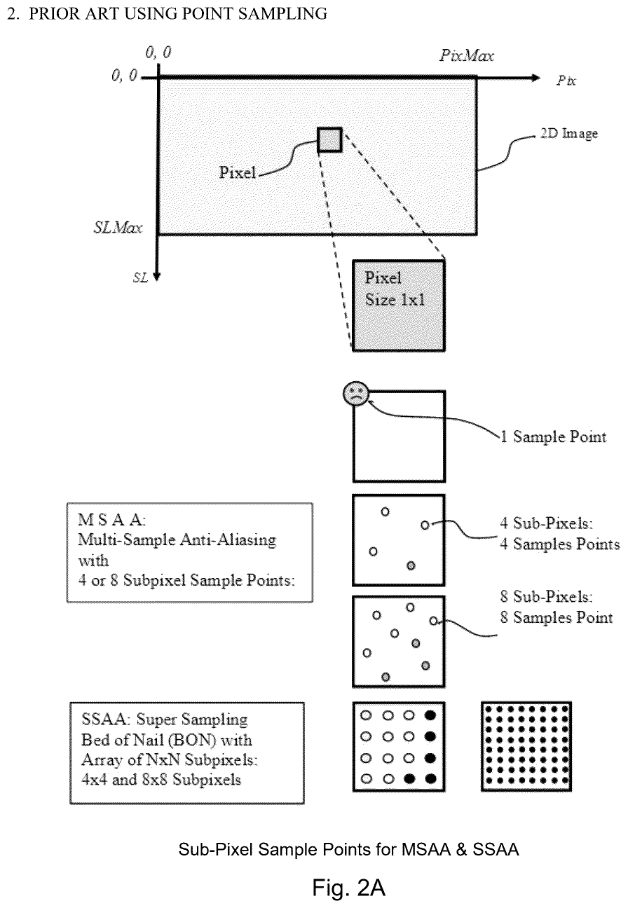

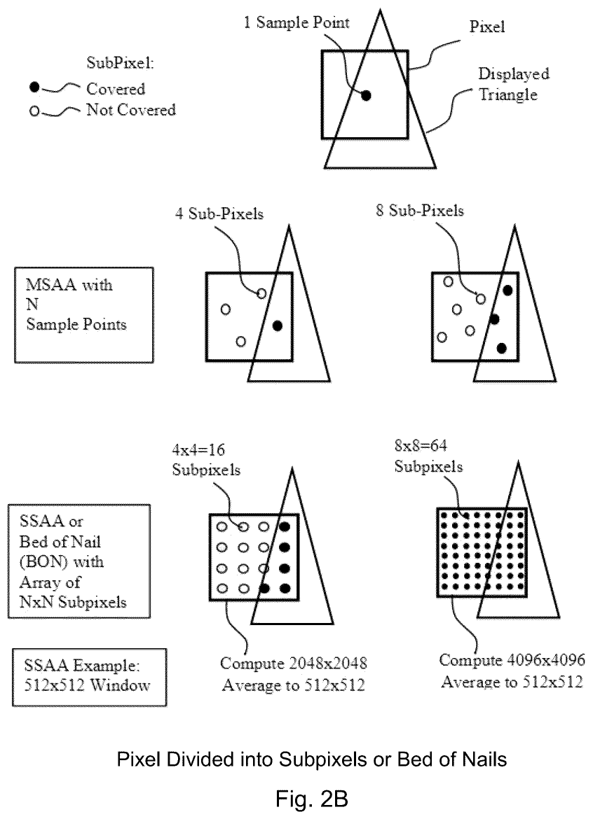

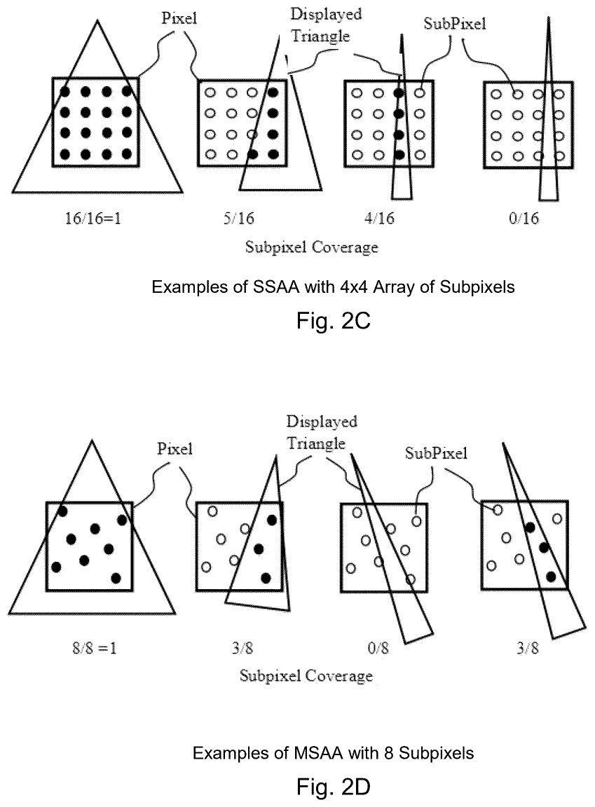

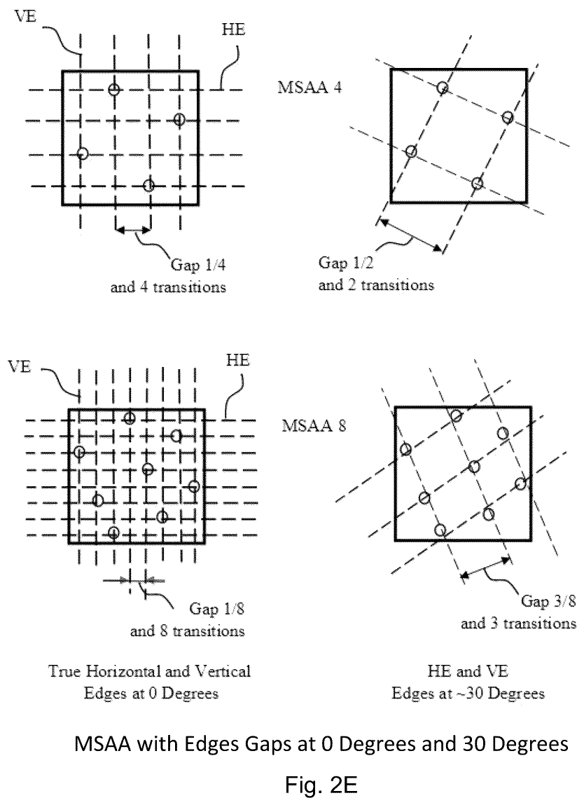

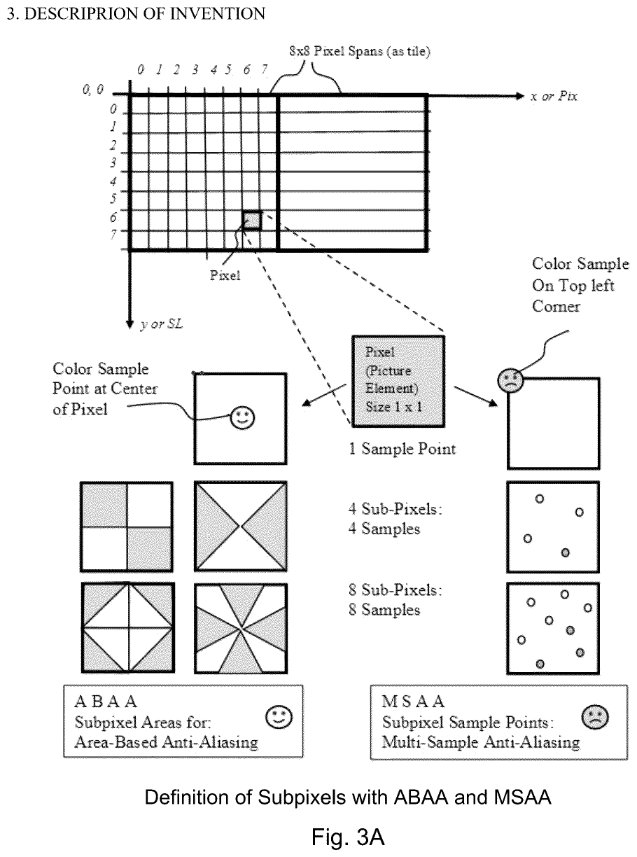

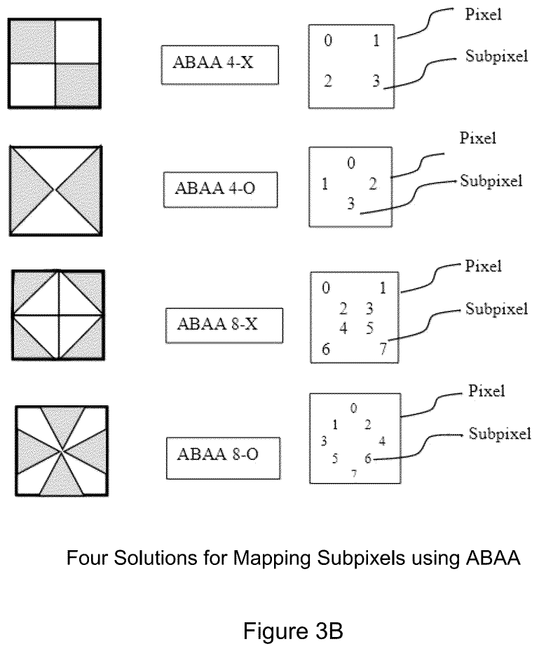

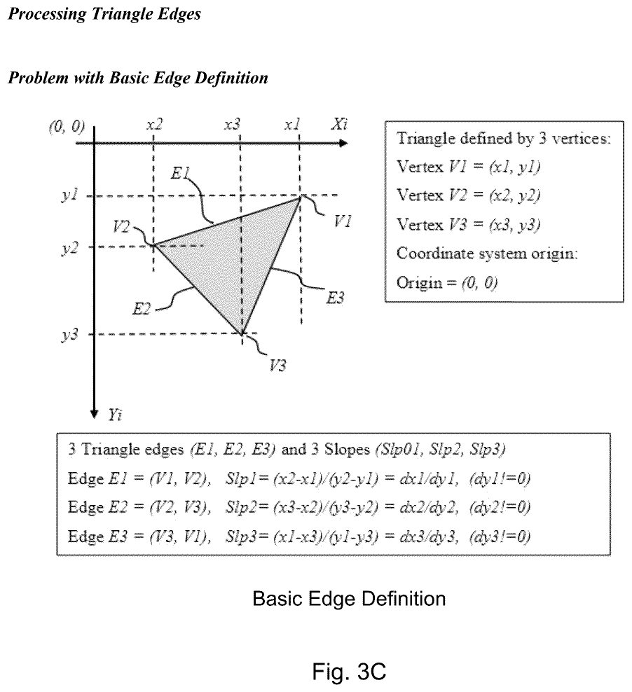

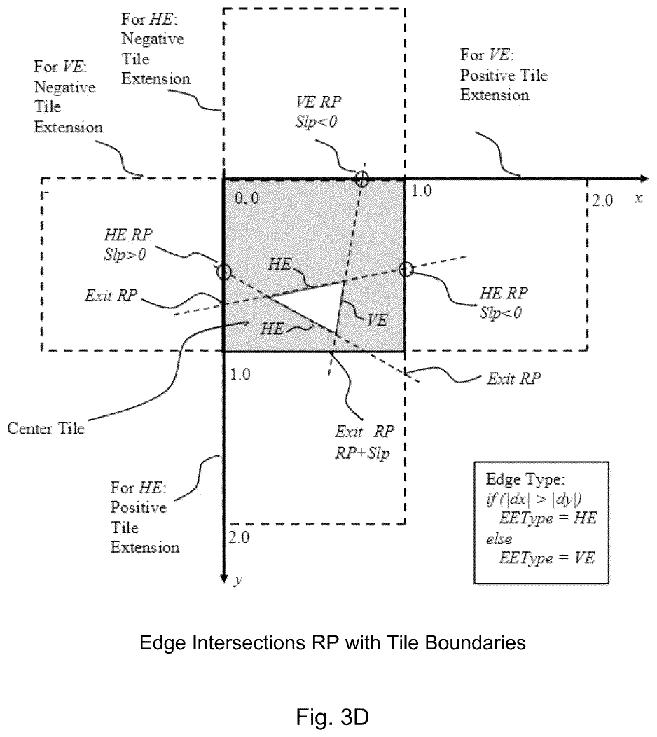

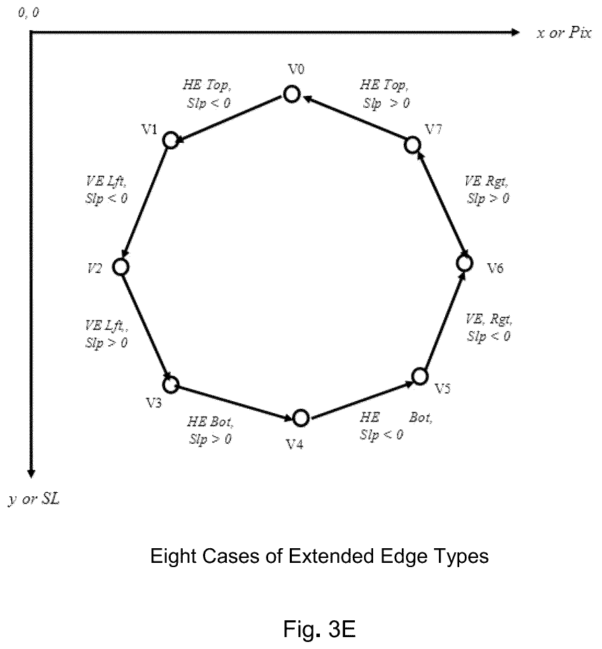

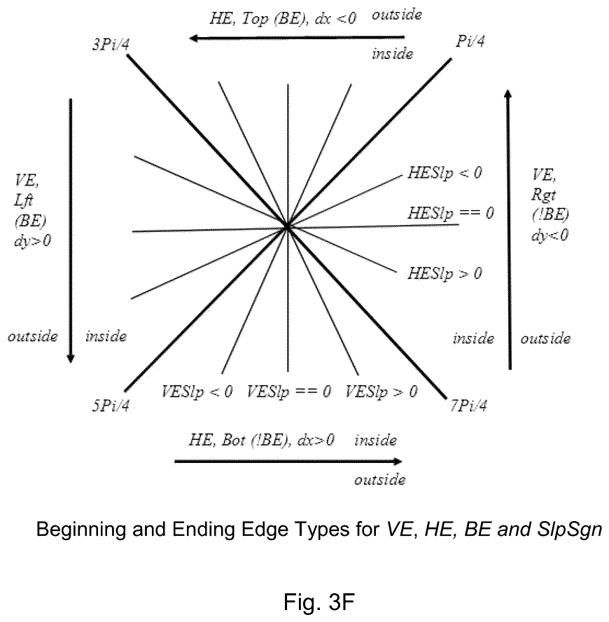

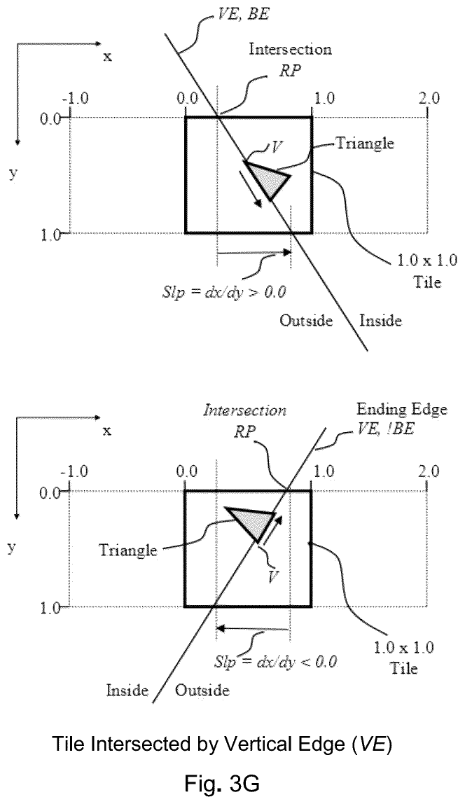

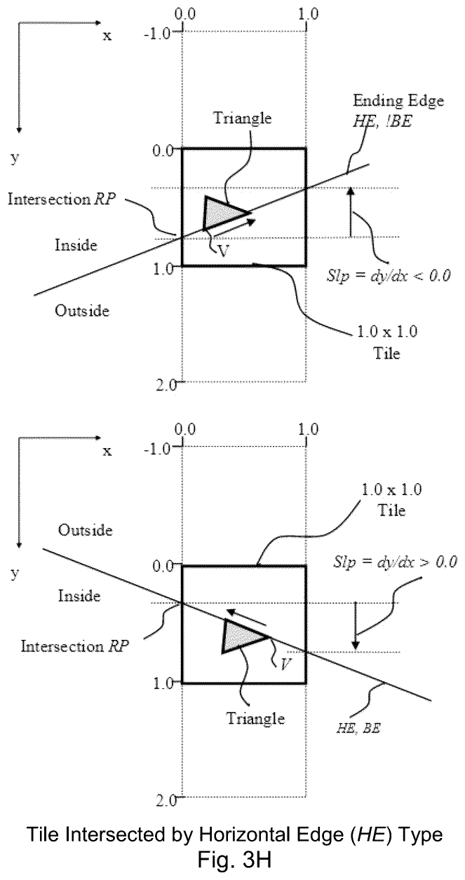

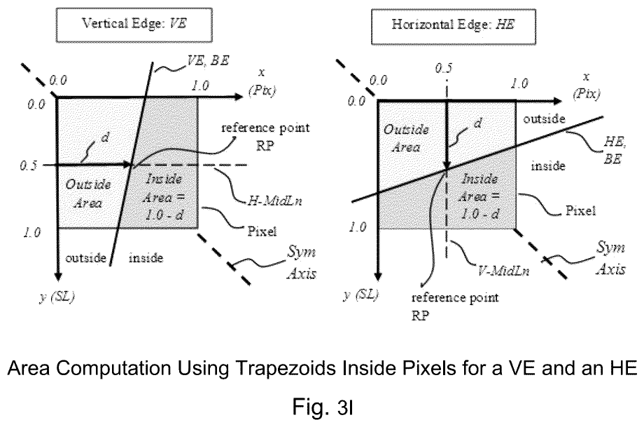

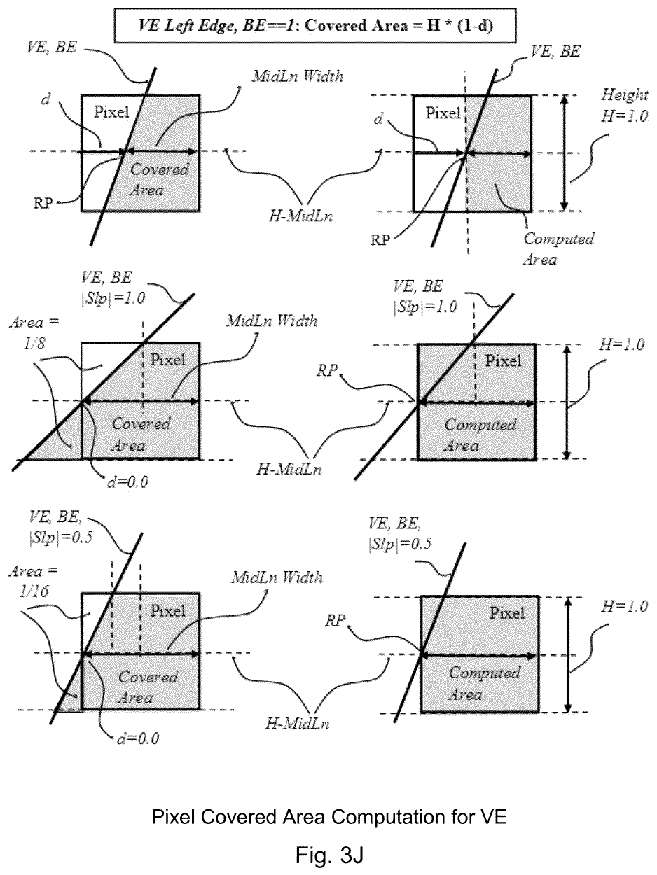

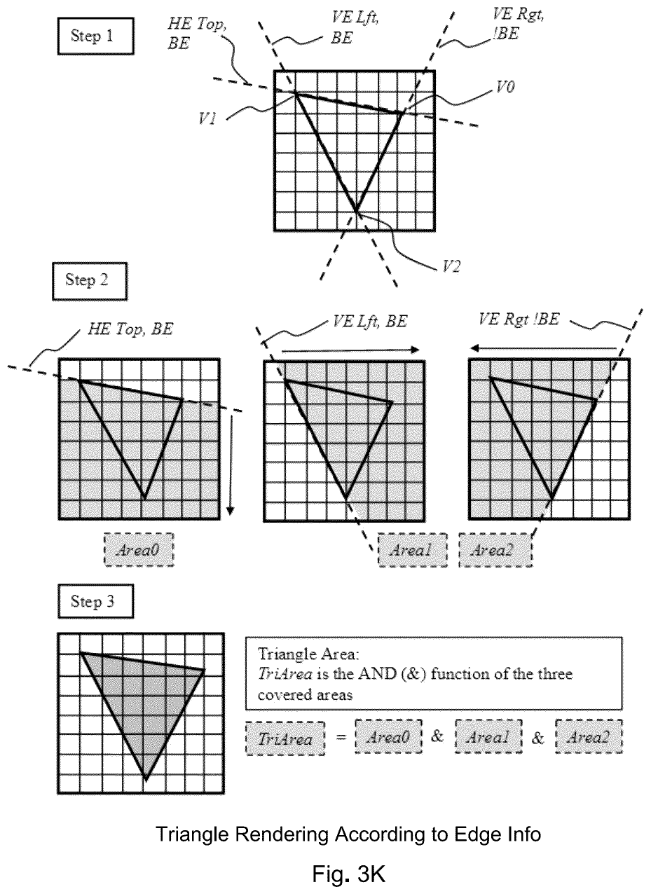

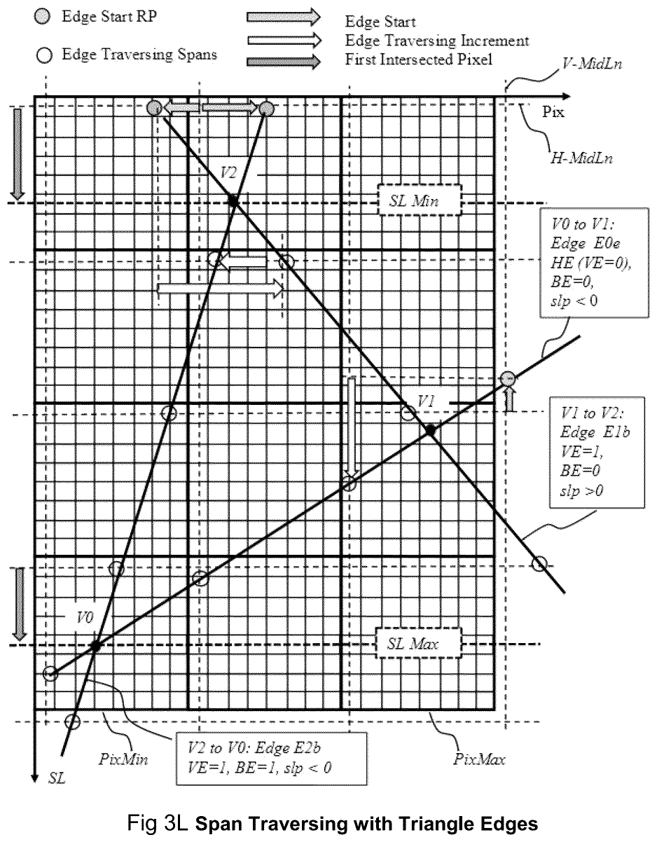

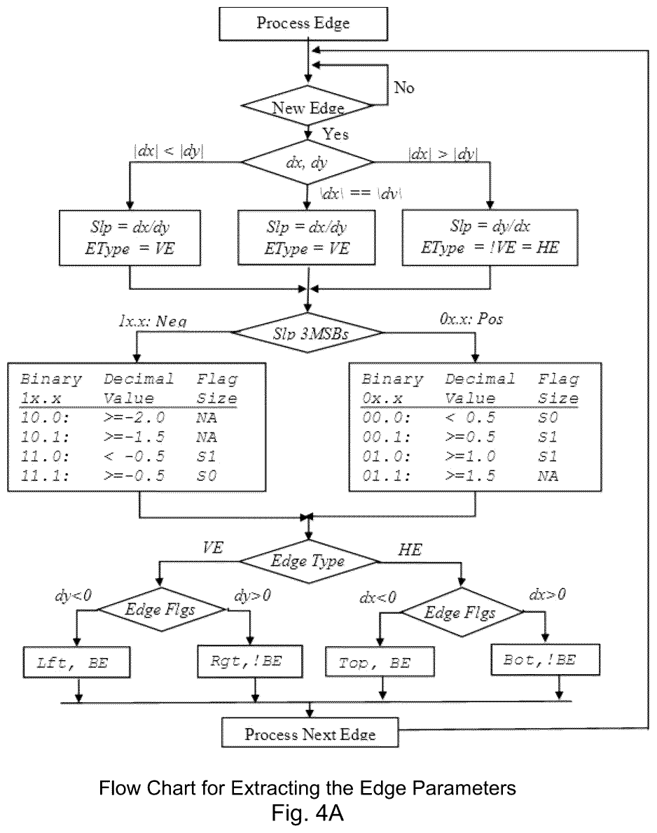

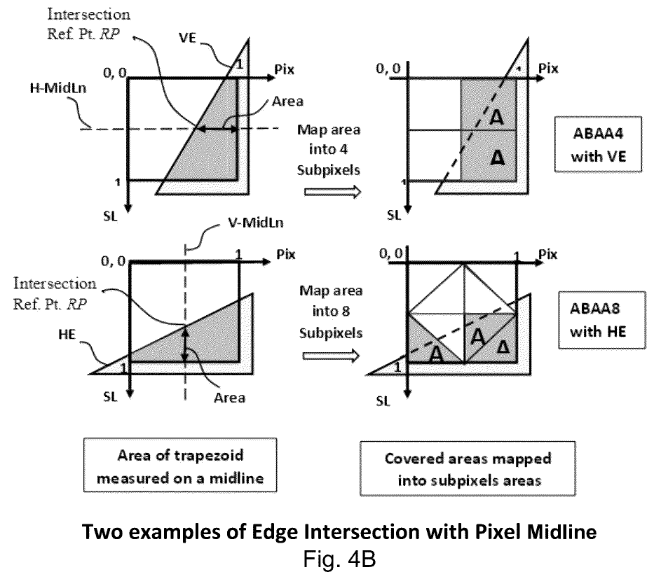

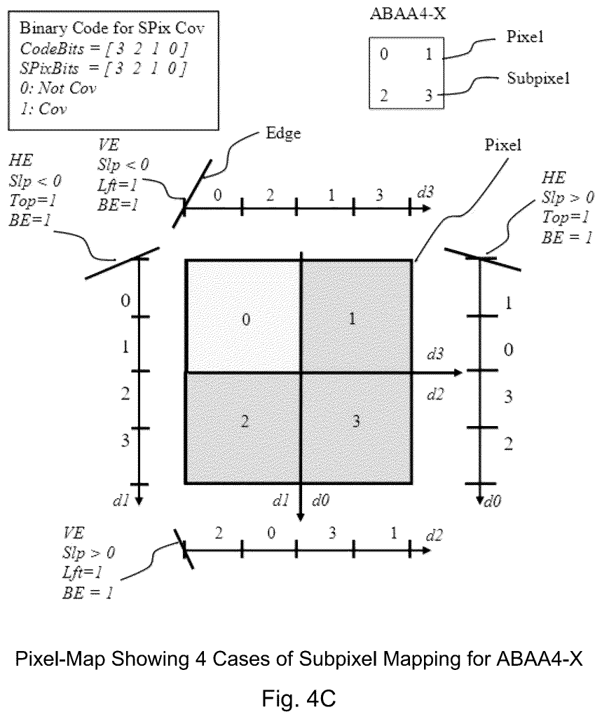

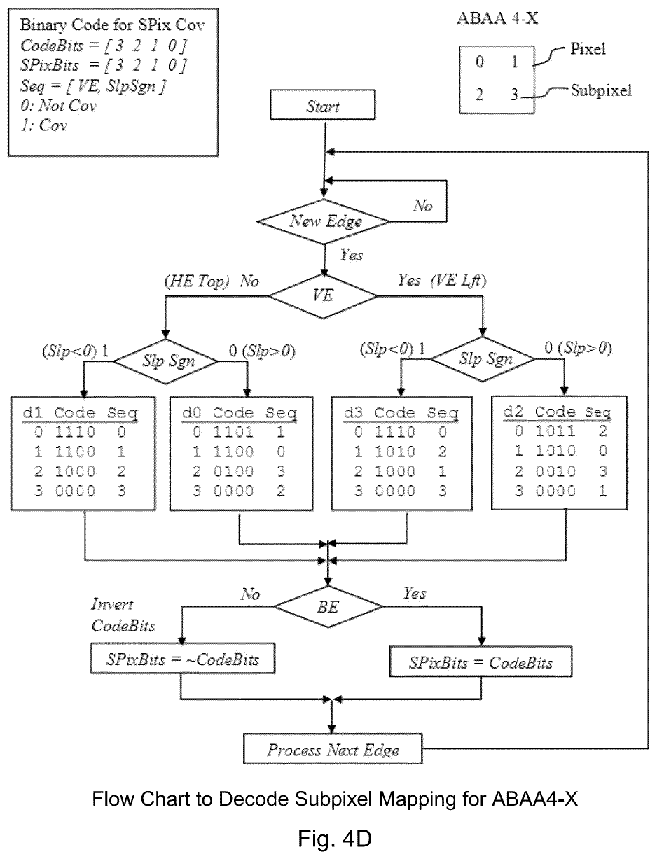

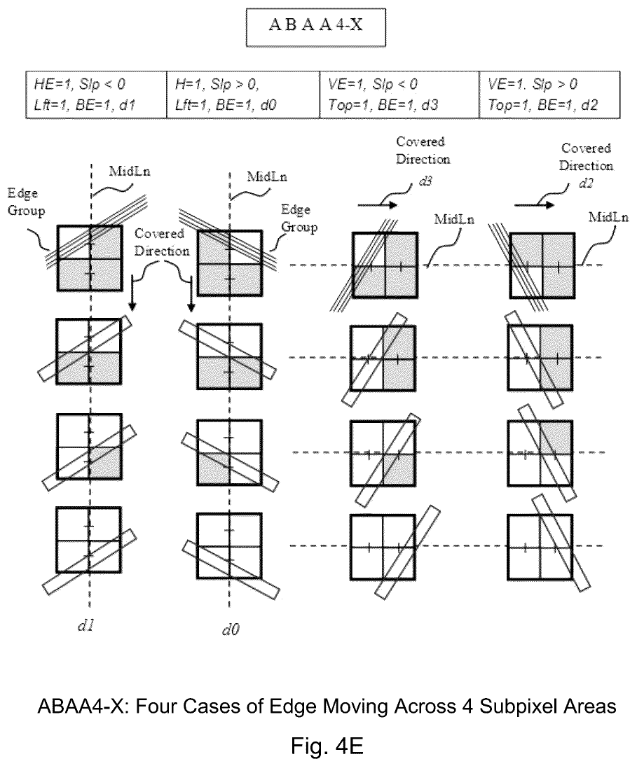

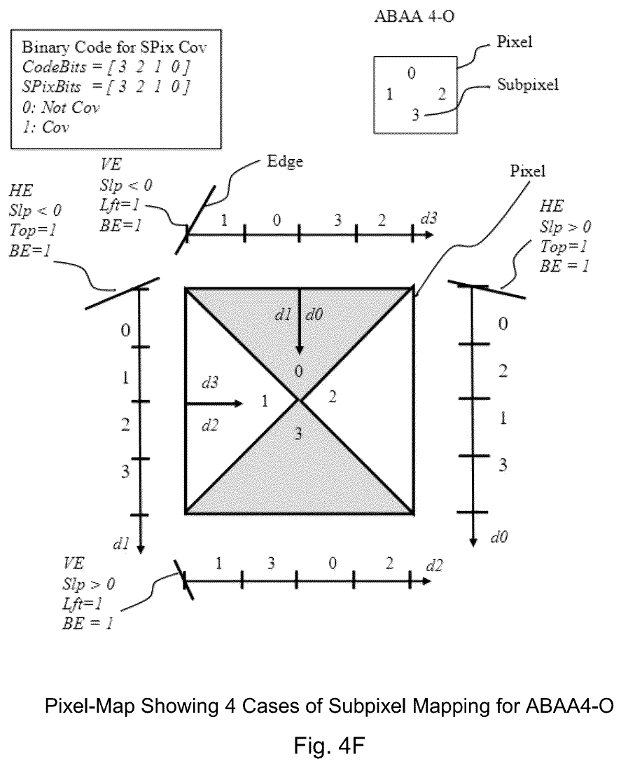

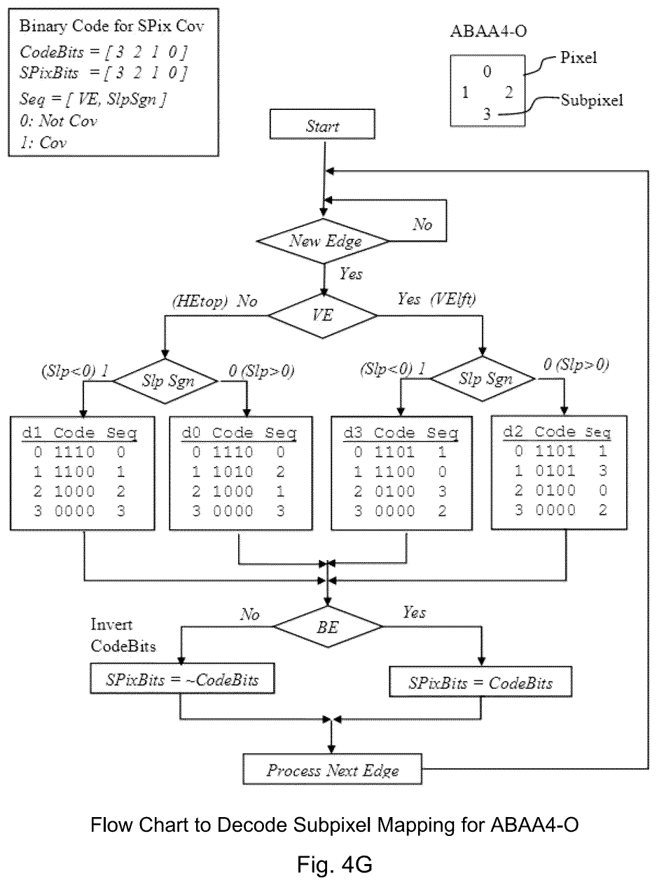

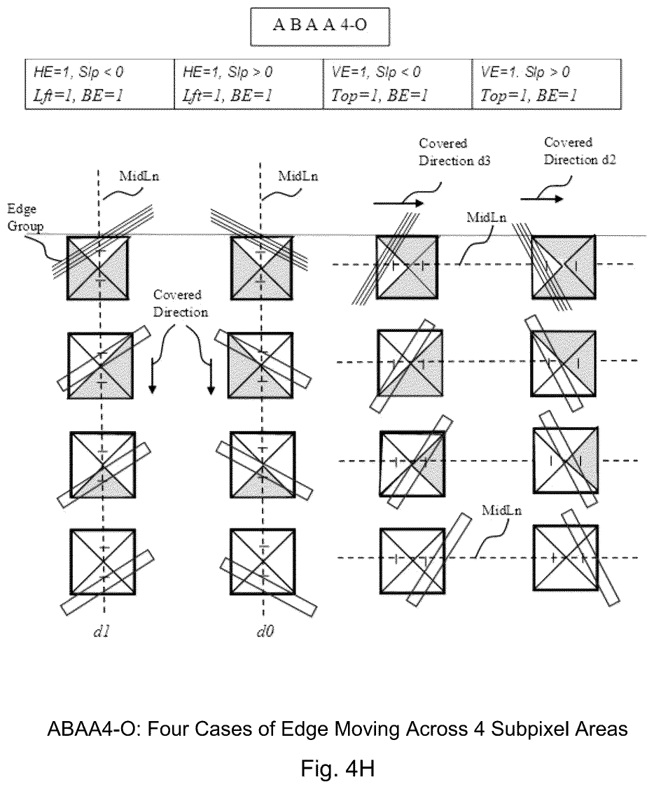

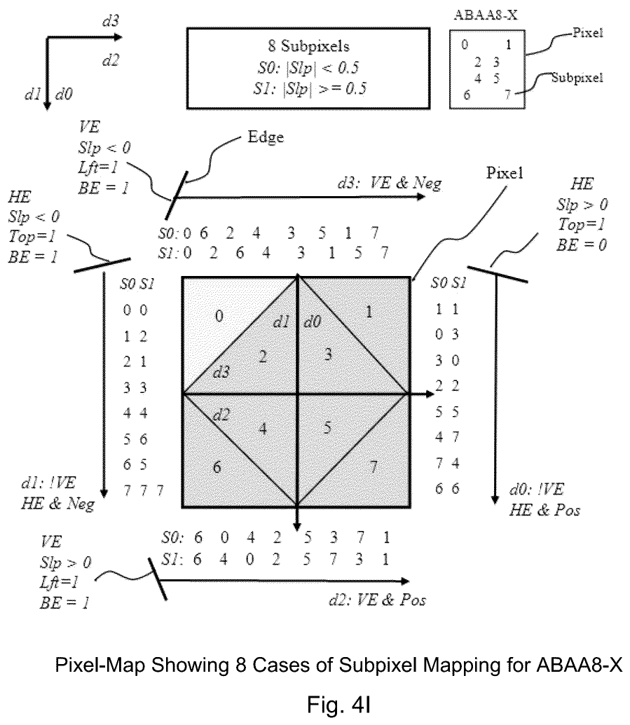

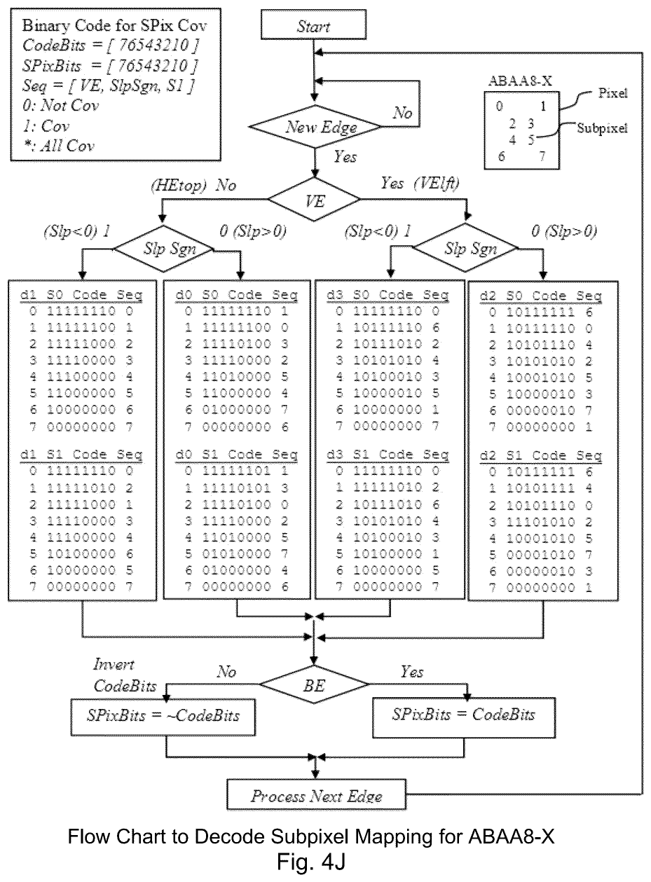

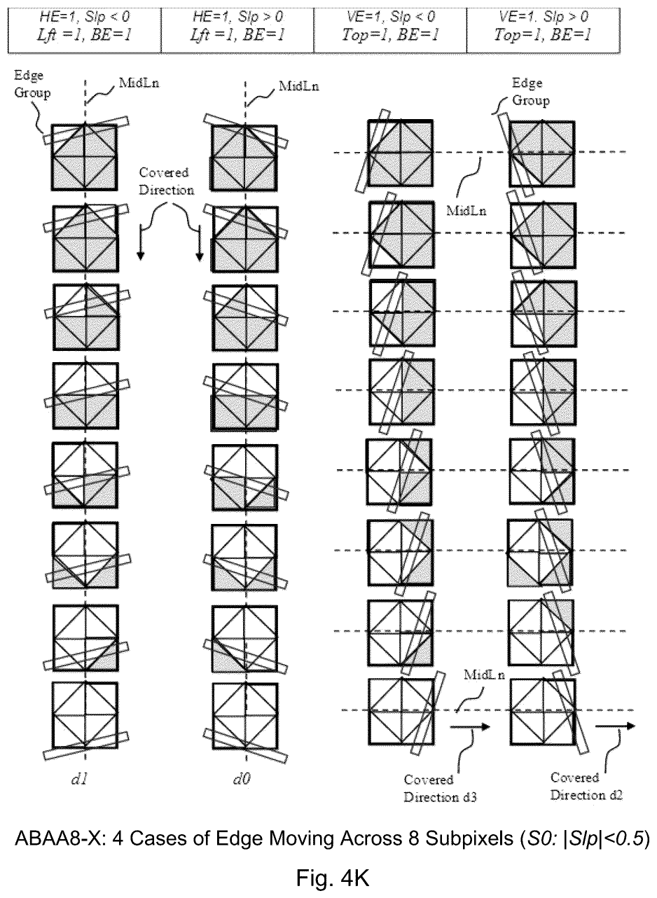

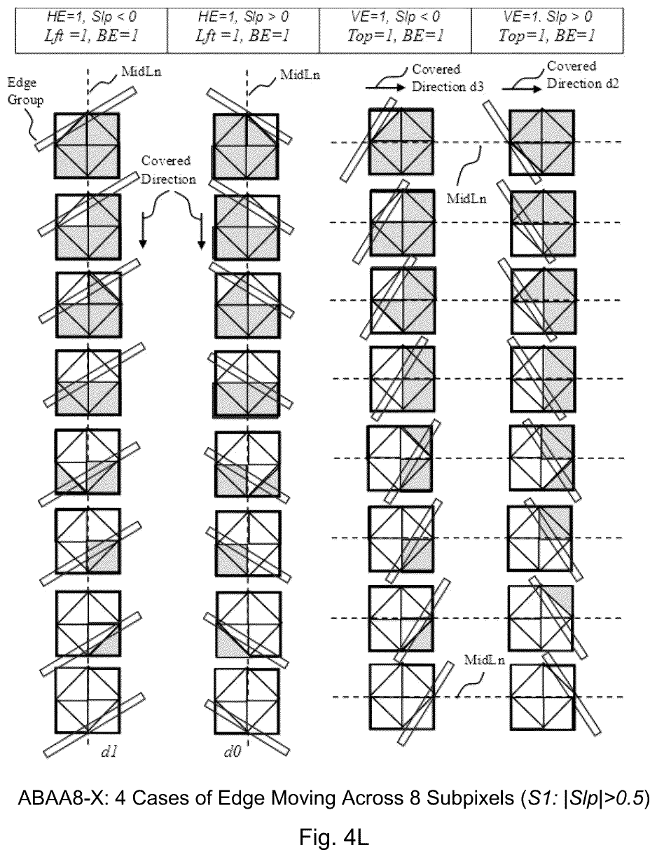

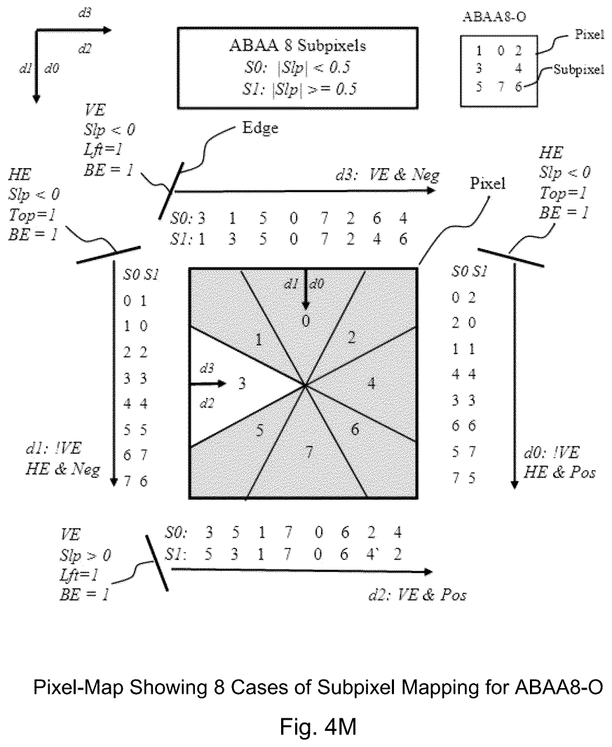

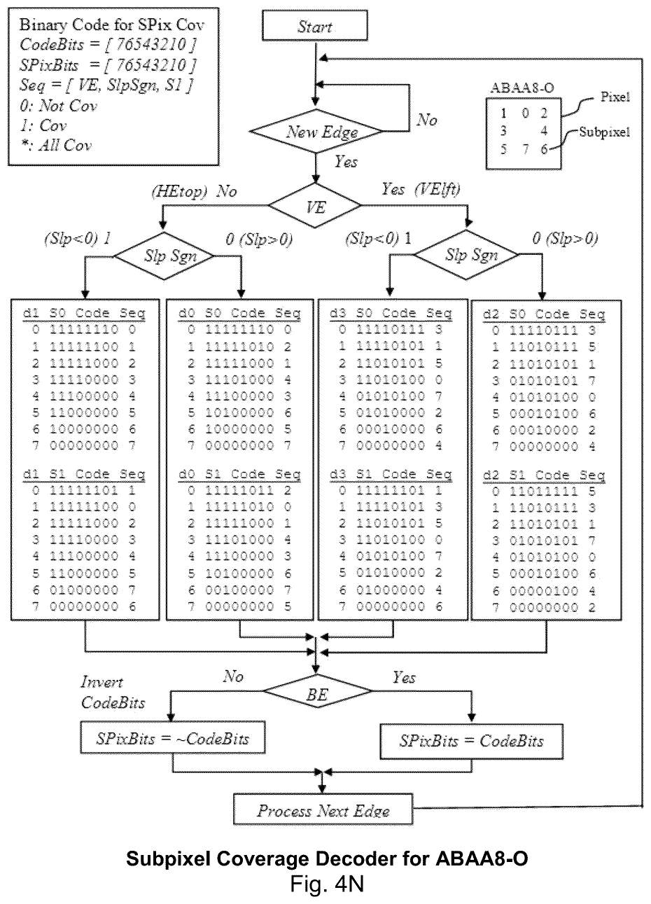

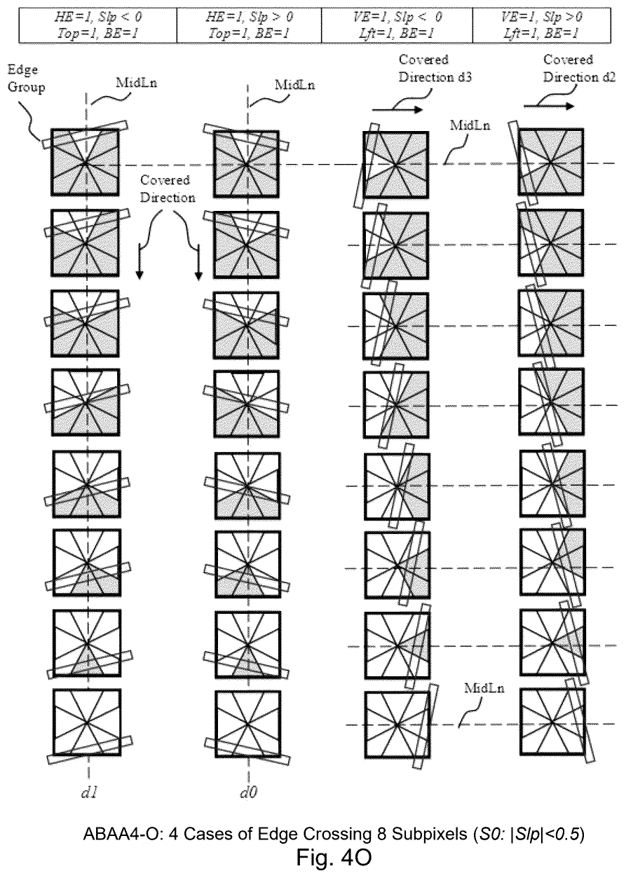

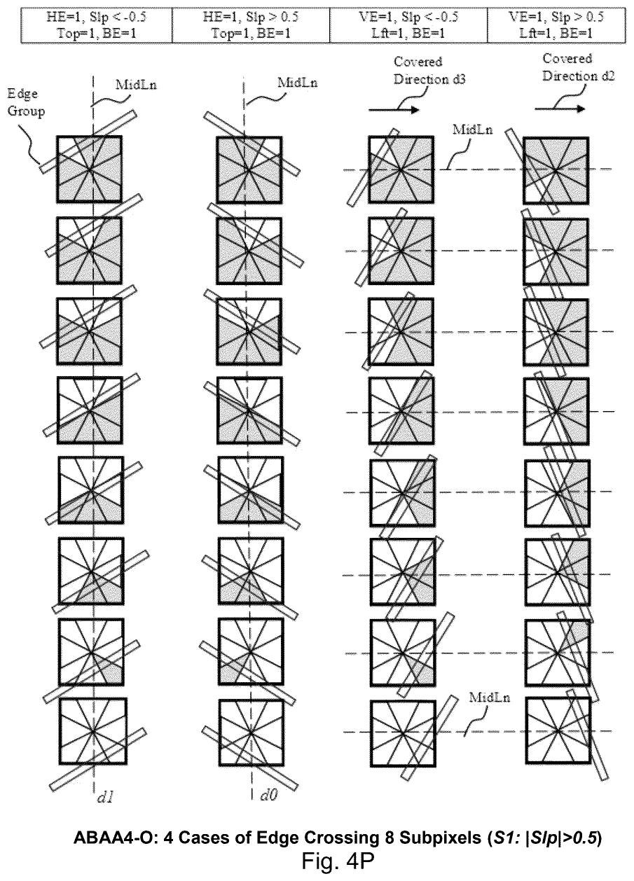

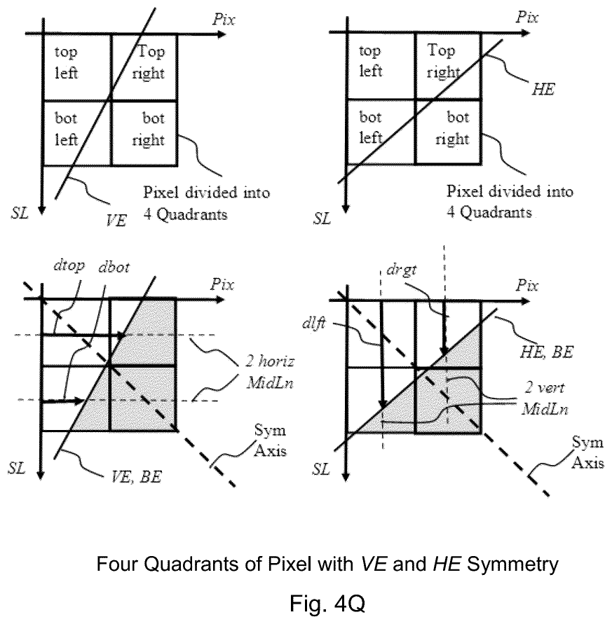

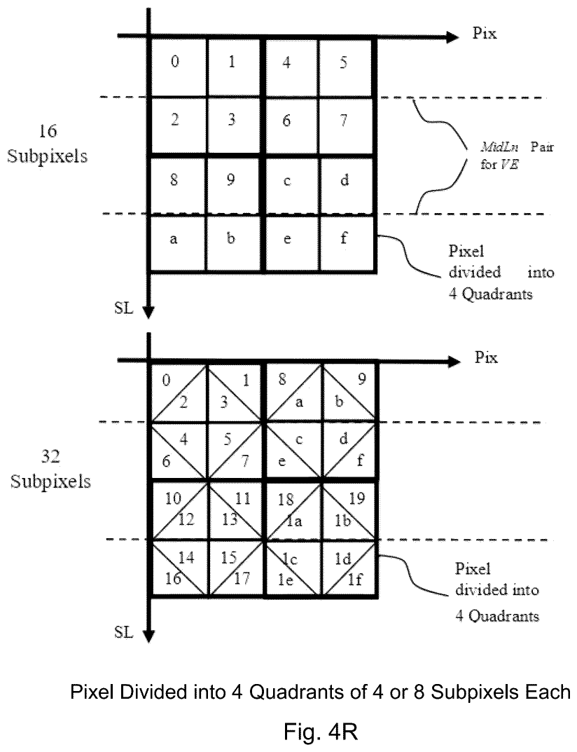

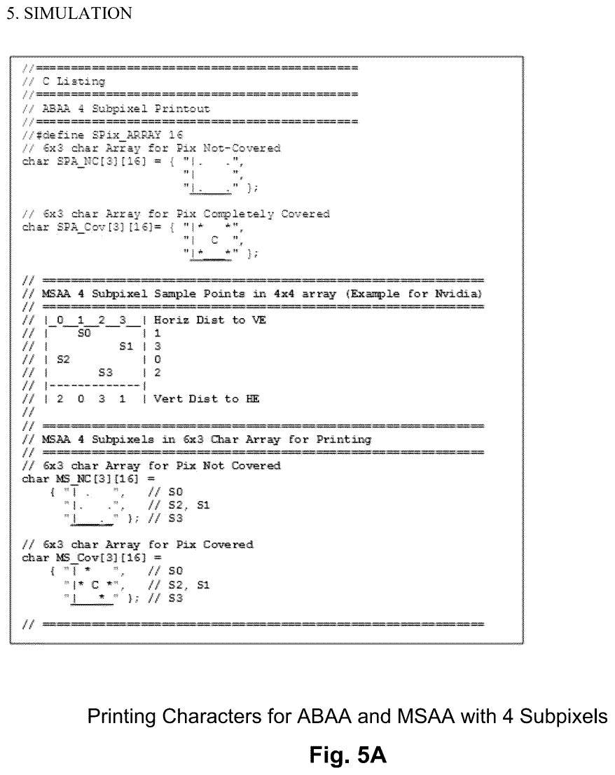

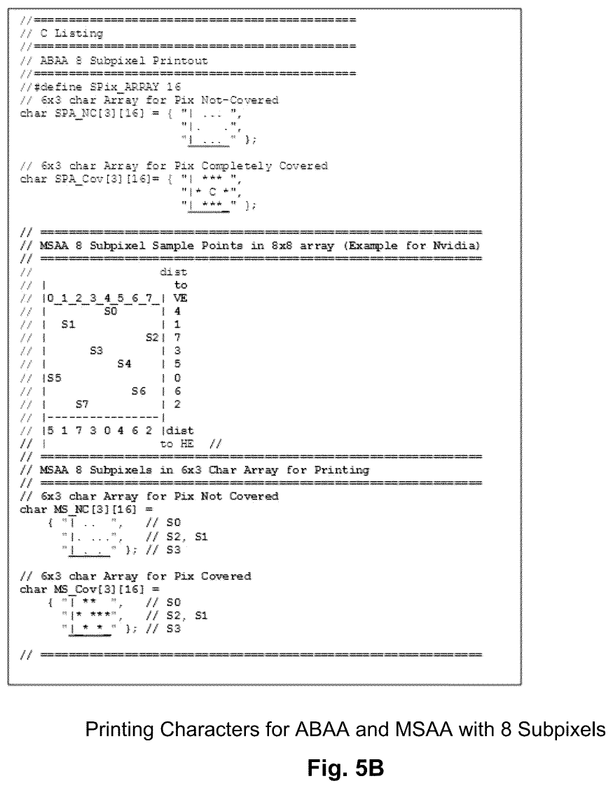

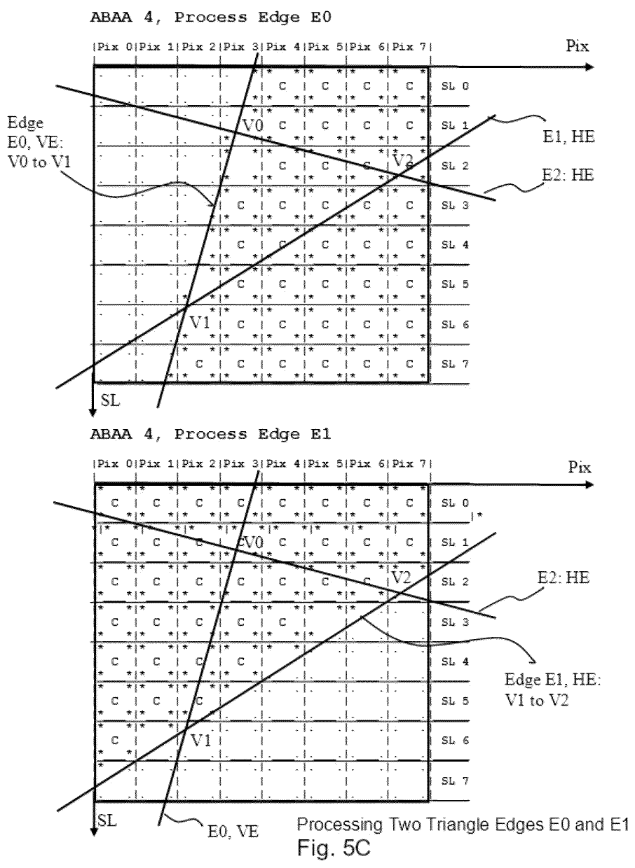

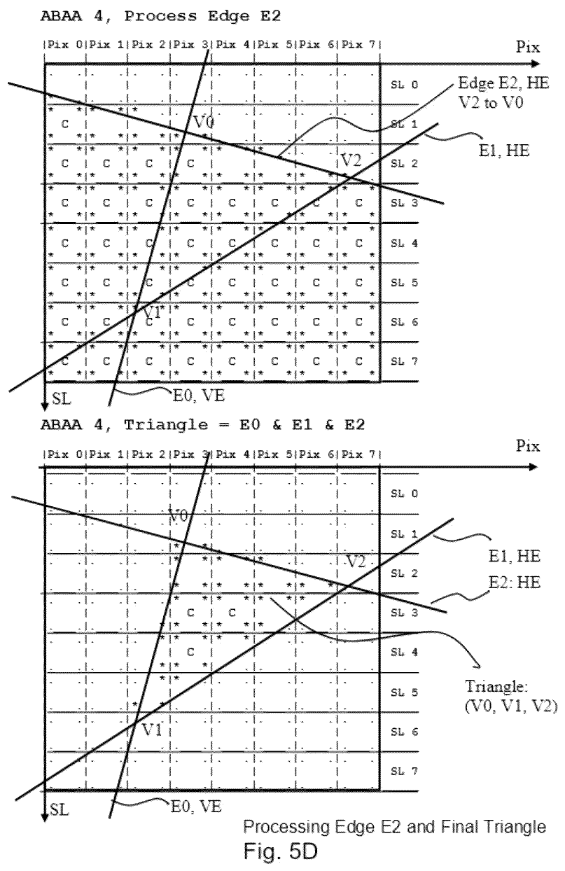

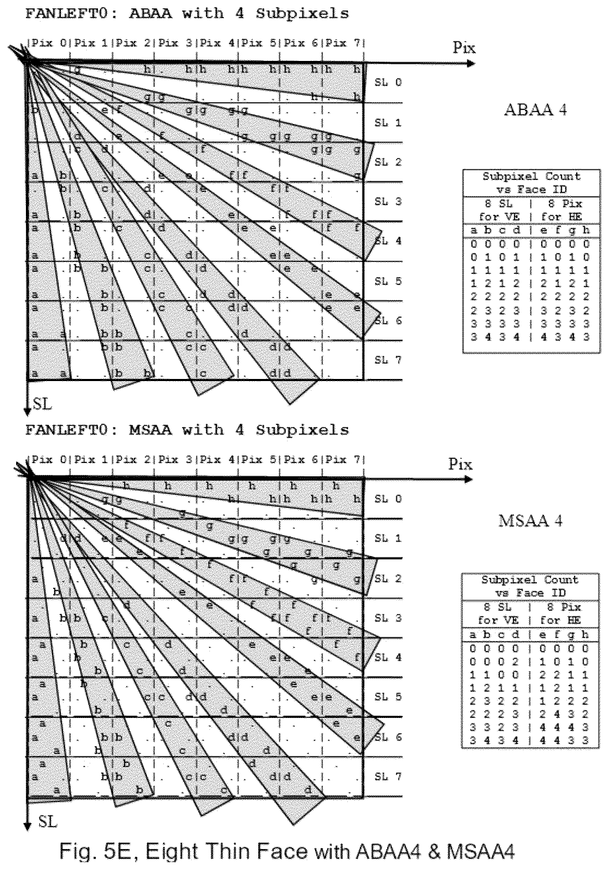

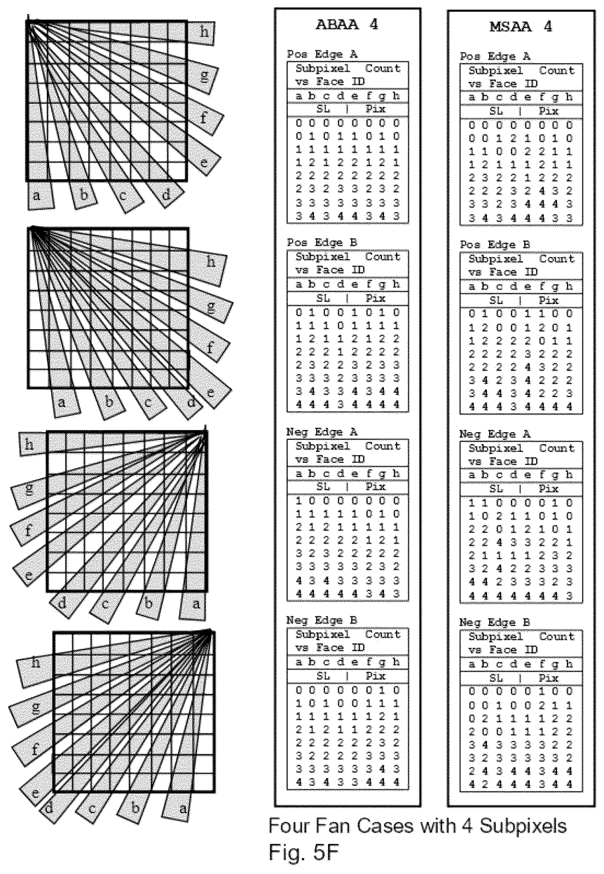

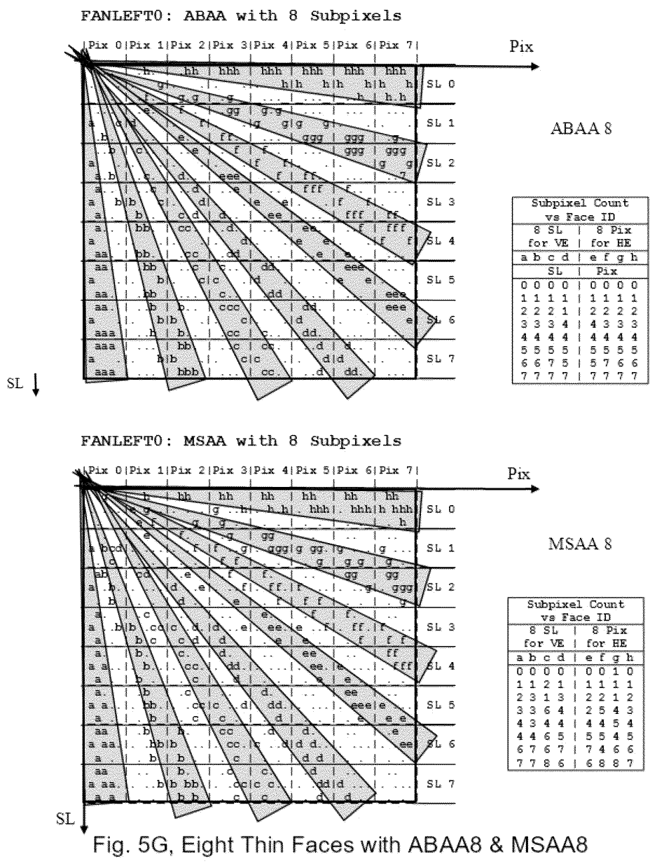

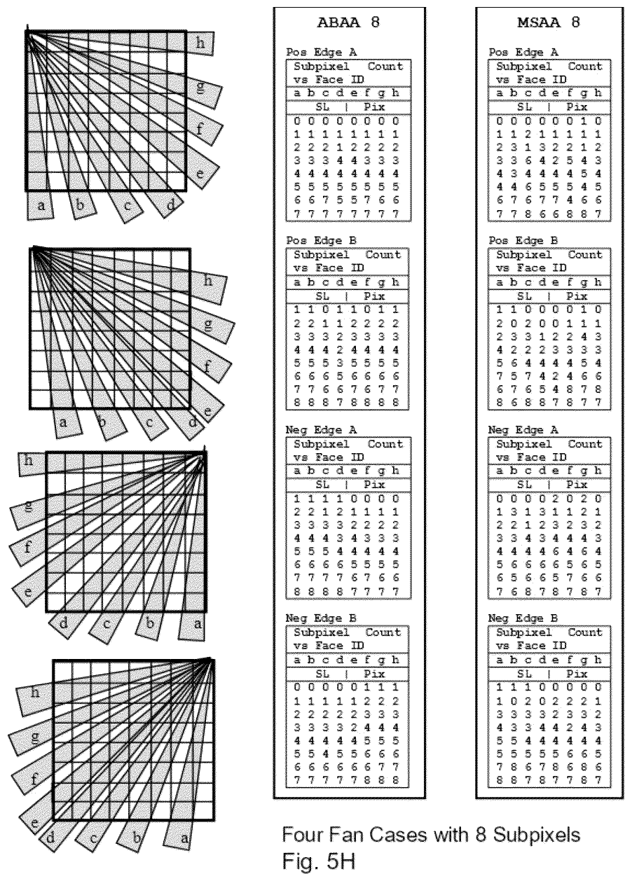

FIG. 1A shows the typical implementation of a gaming area with basic objects from a 3D database. The objects to be displayed are defined in a 3D data base and positioned in the gaming area, using several coordinate systems. The objects in 3D space coordinates (x, y, z) are defined according to the following parameters.
Data Base Origin at coordinate (0, 0, 0) and reference coordinate system (Xref; Yref; Zref)
Viewpoint position: Vp=(xp, yp, yp)
Aircraft coord. sys: (Xa, Ya, Za)
Viewpoint 3×3 Attitude Matrix Ha defined by 3 angles such as Roll, Pitch and Yaw.
Fixed Object Position: Vobj=(xo, yo, zo)
n Object vertices Vj=(xj, yj, zj), where j=0 . . . n.
Triangular faces defined by 3 coordinate vertices Vj=(xj, yj, zj) relative to the object position.
Face normal vectors N, to eliminate back faces.
Moving object position Vm=(xm, ym, zm) and orientations matrix Hm.

### Triangle Processing

The database objects are made of triangles or groups of adjacent triangles. During processing, these triangles are processed one at a time through the 3D and 2D processing pipelines. After processing they end up rearranged together on a 2D image.

Although there can be curved object surfaces defined in the data base, these surfaces have to be converted into triangular features using tessellation (subdivision into small adjacent triangle features) at some point during the processing.

FIG. 1B shows the 3 types of triangles or group of triangles that can be processed by the CIG pipeline.
Triangle
Strip
Fan

### Triangle Processing Pipeline

FIG. 1C shows a typical implementation of a processing pipeline. The processing for computer generated images in real-time (RT) takes place in three concurrent and sequential stages.
Controller
3D and 2D Geometry Processors
Display Processor

Each image scene is comprised of a plurality of objects decomposed into adjacent triangular faces.

The Controller specifies the geometric operations and select object lists to be processed by the 3D and 2D Geometric Processors.

The 3D Processor performs translation and rotation of triangle vertices, followed by Clipping. The 2D Processor projects the 3D vertices onto a 2D image. It computes the slopes of edges connecting the triangle vertices and the color gradients inside of the triangles. The typical size of the image is 1 k×1 k pixels (Picture Elements).

The Display Processor (or Renderer) renders the image by traversing the array of pixels with the triangle edges. It maps the triangle areas onto image pixels, and compare the depth of overlapping triangles. When several faces partially cover a pixel, the portions of faces inside of that pixel are referred to as fragments. When a triangle completely covers a pixel, the computed color is assigned to that pixel. When portions of triangles partially cover a pixel, there can be several cases:
For single sample point, the color of the closest face at the sample point is stored into the frame buffer.
For multiple sample points, the color that most accurately represents the sum of weighted areas of the fragments is assigned to that pixel.

### RT CGI Processing

A typical implementation of a real-time CGI system is done in several processing stages, using dedicated hardware. Most operations are executed concurrently using special purpose processing hardware organized in pipeline fashion. At the highest level, they are identified with overlapping ‘Frame’ computations.
In Frame 0, the CGI controller builds object list of the scene to be displayed on the final image.
Frame 1 consists of the geometric operations in 3D space, followed by projection onto 2D space with triangles defined with 2D vertices, edge slopes and functions gradients.
Frame 2 consists of the image rendering and storing into a display buffer.

### Frame1: Geometric Operations in 3D and 2D Space

The processing steps of Frame 1 are illustrated in FIG. 1D through FIG. 1L.

### Translation

FIG. 1D shows how the triangle vertices are translated from data base coordinate, V(x, y, z), into viewpoint coordinates, Vt=V−Vop.

The data base objects are decomposed into adjacent triangles that are organized into groups of triangles, strips and fans. The triangles are defined by 3 vertices in the 3D space with their coordinate V(x, y, z) relative to the object origin. The objects are positioned according to their object coordinates Vo (xo, yo, zo) in the data base.

### Pyramid of Vision and Rotations

FIG. 1E, shows the viewing window is defined by a Pyramid of Vision in 2 different 3D coordinate systems.

The viewpoint, Vp, with respect to database origin is Vp=(xp, yp, zp),

The data base coordinates are converted into window coordinate using a 3×3 attitude matrix, Ha, and a 3×3 window matrix, Hw.

### Attitude Matrix Ha:

The top image represents a vertex inside of a window in aircraft coordinate system.

The translated vertex Vt=xt, yt, zt) is rotated into in aircraft coordinates Va=xa, ya, za) with attitude matrix Ha

$$Va = ( xa , ya , za ) = Ha * Vt$$

The three rotation angles are defined as roll, pitch and yaw, or (roll, pitch, yaw). The 3×3 attitude matrices (Ha) is computed from these three angles. It defines the 3D geometry of a viewing window such as front, left or right window.

### Window Matrix Hw

The bottom image represents to window in the aircraft coordinate system,

The vertex Va is rotated and scaled into aircraft window coordinate system using the rotation matrix Hw.

The viewing angles of viewing windows could be 60 degrees horizontally and 40 degrees vertically, for example. So, before projection, the display window needs 3 adjustments that are encoded in a 3×3 window matrix, Hw.
Window position, such a front, left or right window,
Scale the window coordinates so that the horizontal and vertical window angles are converted to 90 degrees viewing angles (45 degrees half viewing angles). This is needed for the Clipping operation and to facilitate projection for a window at 45 degrees half angles.
Scale the image according to the display size: horizontal (PixMax) and vertical (SLMax)

The vertex Va=xa, ya, za) in aircraft coordinate is rotated and scaled into a vertex in window coordinates Vw=(xw, yw, zw) with a window matrix Hw.

$$V w = ( xw , yw , zw ) = Hw * Va$$

### Rotation Matrix Hr

The combined rotation matrix, Hr, is obtained by pre-multiplying Ha with Hw:

$$H r = Hw * Ha$$

$$Vw = Hr * Vt$$

The resulting vertices are in window coordinate system Vw(xw, yw, zw)=Hr*Va(xa, ya, za)

### Clipping

FIG. 1F shows how the Clipping operation removes portions of triangle that are outside of the displayed window. Before the projections, Clipping discards the portions of triangles that are outside of the pyramid of vision. There 4 window's edges are defined as: left, right, top and bottom.

Before projection, the 3D vertices, Vw=(xw, yw, zw), are converted into window edge coordinates:

The 3D distance, zw is the distance between the viewpoint (0, 0, 0) and the point Vw(xw, yw, zw) in window coordinate.

The image plane is positioned at the distance zw=1 from the viewpoint.

The depth coordinate zdepth is the distance representation in 2D space after the projection.

After projection, the image plane is at distance zdepth=1.0 from the viewpoint.

Project 3D Vertices into a 2D Image Plane

FIG. 1G shows how the vertices are projected from 3D to 2D.
1) Before projection, the coordinates relative to window center are translated into xleft and ytop image coordinates, using the depth coordinate zw.

$$xleft = ( x w + z w ) / 2$$

$$ytop = ( yw + z w ) / 2$$

$$zdepth = zw$$

2) The vertices are then converted into projected image coordinates (xi, yi, zi), by dividing the xleft and ytop coordinate by the distance zw.
   The projected X is equal to the vertex distance from the left plane, xleft, divided by its distance zw from the Viewpoint: xi=xleft/zw.
   The projected Y is equal to the vertex distance from the top plane Ytop, divided by its distance zw from the Viewpoint: yi=ytop/zw.
   In the image plane coordinate system, because of the division, the value of the depth variable, zw, is not linear with respect to the projected coordinates xi and yi. For this reason, in image coordinates system the inverse distance, 1/zw, is used as the image depth coordinate. The inverse depth, zi=1/zw, is linear in the image coordinate system.
3) The image size is determined by the horizontal (PixMax) and vertical (SLMax) resolution of the display monitor. Since the size in pixels is not a power of 2, the image coordinates have to be scaled according to PixMax and SLMax.

For a 1 k×1 k image, the 2D vertex components can be represented by 16-bit positive fixed-point binary numbers having 2 zero signs, 10-bit integer and 4 bits of fraction.

$$x = xi * PixMax / 1024$$

$$y = yi * SLMax / 1024$$

$$z = zi$$

$$x < 1. 0 ; y < 1.0$$

### Process Triangle in XY Image Coordinates

FIG. 1H shows how the 2D parameters for the triangle edges are computed. Following the vertex projection onto the window image plane, the triangle vertices are processed in 2D space.

The projected triangles consist of 3 vertices and edges connecting theses vertices in (xi, yi) image coordinates. Each pair of vertices is connected by an edge with a slope dx/dy or dy/dx. The output of the Geometric Processor consists of 2D triangles defined by 3 vertices and 3 edges with color and other attributes.

### Frame 2: Render Image in 2D Display Window

FIG. 1I describes how the projected image is mapped into a 2D array of pixels.

### Image Rendering in 2D Image Plane

Following the geometric processing in 2D, triangles are processed by an Image Renderer. The task of the Image Renderer is to draw 2D triangles by mapping them into pixels. Implementation of the Image Renderer can vary. While each triangle is processed separately, all the triangles are put back together to form a 2D image. The rendered image is stored into a Frame Buffer. For each pixel, there corresponds an address in the Frame Buffer.

The image size is determined by the horizontal (PixMax) and vertical (SLMax) resolution of the display monitor. Each image pixel is of size 1×1 and has a uniform color defined by 3 color components, Red, Green and Blue (R, G, B).

In this figure, there are 2 approaches for selecting a pixel sample point:
On the left side, sample point at the ‘Center’ of the pixel.
On the right side, sample point on the ‘Top-Left Corner’ of the pixel.

When only one sample point is used to compute an image, this result into aliasing effects consisting of jaggies (jagged edges), edge crawling and face popping. In order to reduce aliasing effects, several sample points (or subpixels) should be used inside of pixels.

In order to compare the depth of the sample point of the projected triangles, the depth of the sample points is stored in a Z-Buffer of size similar to the Frame Buffer (also called Color Buffer). The depths of the samples are compared. The samples closer to the observer are selected and the other are discarded. This limits the 2D image to 1 sample per pixel. In order to increase the image resolution, the pixel can be divided into several sample points, or subpixels. An image is computed for each subpixel. The resulting image is obtained by averaging the image computed for all the subpixels within a pixel.

For the purpose of processing, the image is sometimes organized into small square areas of size 8×8 or 16×16 pixels, referred to as tiles or two-dimensional spans. For image processing, such as image rendering in CGI or data compression for HDTV, there are advantages when the image is decomposed into square tiles.

### Image Coordinates

FIG. 1J describes how the projected image can be described by two dependent 2D coordinate systems: a fixed point and an integer coordinate system.

Horizontal axis from left to right, using:
fixed-point x coordinate (between 0.0 and 1.0)
integer pixel (Pix) coordinate (between 0 and PixMax)

Vertical axis from top to bottom, using:
fixed-point y coordinate (between 0.0 and 1.0).
integer Scanline (SL) coordinate (between 0 and SLMax)

The image coordinates are defined by two axes with x and y coordinates, as follows. Depending on the context, the values on the coordinate axes can be defined with fixed-point coordinates, or with integer coordinates.

In the figure, the image is represented as a two-dimensional array of pixels of integer size:

$$PixMax * SLMax$$

The coordinates can be expressed as:
Fixed points image coordinates (x, y).
For a 1 k×1 k image, the 2D vertex components inside of the image can be represented by 16-bit positive fixed-point binary numbers having 2 zero signs, and 14 bits of fraction. 00.bbbbbbbbbb bbbb
This number consists of 3 fields:
ss bbbbbbbbbb.ffff
The 2 sign bits (ss) extend the image beyond the window edges.
The (Pix, SL) pixel coordinates are defined by the 10-bit integer portions of the coordinates (x, y)*2\hat{ }10, that is: (bbbbbbbbbb).
The 4 LSBs, (ff), represents 4 bits of pixel fraction (in x and y direction)
Integer pixel coordinates (Pix, SL).
In order to define (Pix, SL) coordinates, the (x, y) foxed point coordinates are multiplied by 2\hat{ }10=1024.
The result is (x, y)*2\hat{ }10 with a format consisting of 2 signs (ss), 10-bits of integer (bbbbbbbbbb) and 4 bits of fraction (ffff)
The (Pix, SL) coordinates are used for memory addressing.

In the Image Display system, the image is retrieved from the Frame Buffer using coordinates (Pix, SL) as memory address. The window image is converted from digital to analog. The image it then displayed on Video Monitors or other image display systems.

In a state-of-the-art implementation, the pixel colors are stored in a Frame Buffer and their Z-distance are stored in a Z-Buffer. In the early implementations there were only 1 sample per pixel stored in the Frame Buffer. In this implementation, there is only one color and one Z-distance per pixel.

### Single Point Sampling

Images produced with single point sampling can achieve the fastest frame rate, at the expense of aliasing artifacts such as “stairsteps” and “narrow faces breakup”. These artifacts are more noticeable in real-time (RT) CGI applications, such as when simulating visual scenes for flight training or playing computer video games. In moving images, stairsteps result in “crawling”. Also, narrow faces breakup result in “faces popping in-and-out of scenes”.

FIG. 1K shows 2D images displayed using only one sample point per pixel. Using 1 sample point per pixel results in artifacts described as stairstep and crawling. This is also referred to “jaggies”.

FIG. 1L shows how faces narrower than 1 pixel wide can cause “narrow face breakup”.

In the Image Display system, the image is retrieved from the Frame Buffer using (Pix, SL) coordinates and converted from digital to analog. The image it then displayed on Video Monitors or other image display systems.

### 2. PRIOR ART USING POINT SAMPLING

### Brief Description of the Drawings

FIG. 2A illustrates how subpixel sample points for MSAA & SSAA are selected.

FIG. 2B shows a pixel with subpixel sample points or Bed of Nails (BON).

FIG. 2C shows examples of Super Sampling AA (SSAA) with 4×4 array of subpixels.

FIG. 2D shows examples of Multi-Sample AA (MSAA) with 8 subpixels

FIG. 2E shows the edge gaps for MSAA with edges at 0 Degrees and 30 Degrees

### PRIOR ART USING POINT SAMPLING

FIG. 2A shows several approaches using sample point. These approaches are referred to Single Sample Point, Multi-Sample Points (MSAA) and Super-Sampling (SSAA).

Most of the Prior Art methods for AA are using “Point Sampling’. It is a legacy of the basic Z-buffer approach for rendering 3D Computer Generated Imagery (3D CGI).

Refer to examples in FIGS. 2A and 2B

One of the earliest approaches to AA was Super Sampling. It consists of computing an image at a higher resolution than that of the target image using one sample point per pixel. Then the high-resolution image is reduced to the desired resolution with filtering or averaging. Since there are no time constraints, large images can be computed offline using high-speed general-purpose computers. For example, for 4×4 SSAA, the image is computed at 2048×2048, then reduced to a 512×512 image. The SSAA approach can also be thought as having an image of 512×512 pixels, where each pixel contains an array of 4×4 Sample Points, or subpixels. The sample points inside of pixels can also be referred to as bed-of-nail. The computing time is increased by 4×4=16 times. This approach produces AA images with mixed results. It is very computation intensive and cannot be used for RT CGI.

For RT CGI applications, AA algorithms are limited to methods that can produce images at the field rate, that is 60 images per second. The most commonly used method AA in RT CIG systems relies on taking Multiple Sample Points within image pixels. The MSAA approach can produce images with AA, but at reduced performance, when compared to Single Points sampling. With MSAA, images are computed for 4 (or 8) subpixel sample points inside of pixels, followed by averaging. The processing time is increased by 4 (or 8) times Although this approach is also computation intensive, it can be used for RT CGI with a higher cost or degraded performances.

In FIG. 2B, there are examples of single sample point, MSAA and SSAA, using one or more subpixels inside of a pixel. These configurations are often referred as bed-of-nails is also referred and subpixel sample point inside of a pixel. The nails covered by the triangle are shown in black.

SSAA with Array of 4×4 Subpixels

In FIG. 2C, there are SSAA examples of an array of 4×4 Subpixels, for a total of 16 Subpixels. As can be seen, for thin triangles, the number of subpixels can jump from 0 to 4, when an edge is aligned with a row of subpixels. For example, this occurs when a thin vertical triangle moves sideways, or a thin horizontal triangle moving upwards. This is a disadvantage of subpixels organized in array form. On the other hand, the array of Subpixels is well suited for AA filters where different weights are assigned to subpixels depending on their position within the array. When using a larger array of subpixels, such as 8×8 Subpixels, for a total of 64 Subpixels, the problem with narrow triangles is reduced.

MSAA with Subpixels

In FIG. 2D, there are MSAA examples, with 8 subpixels. By placing the subpixels into positions where no more than two are aligned, this result into a more efficient of the use of subpixels. But there is still a problem when a triangle edge is aligned with two subpixels. With 8 subpixels there are at least 7+6+5+4+3+2+1=28 subpixel pairs. In this example, the number of subpixels can jump from 0 to 2, or 0 to 3, when triangles edges are aligned with groups of subpixels.

### Solutions of the Eight-Queens Puzzle.

One approach to MSAA is to position the subpixels according to solutions of the eight-queens Puzzle. In this approach, the pixel is organized as an array of 8×8 subpixel locations. For a solution with 8 subpixels, only 8 locations are selected among the possible 64 locations. These 8 subpixels occupy squares like the queens on a chessboard. In order to solve the puzzle, the 8 Queens have to be positioned so that no queen can threat another queen. This solution works well for horizontal and vertical edges, But, it does not work as well for other angles.

In these approaches, the number of covered subpixels determine the weight to be applied to the covering face. There are 2 main disadvantages for approaches that use sample points:
They require the same image to be computed with several sample points, followed by averaging or filtering. These approaches are time consuming and have poor performances for real time applications.
No matter how many sample points are used, there are always gaps between the sample points where narrow faces can alternate between visible and not visible. This results in faces popping in-and-out of the scenes.

FIG. 2E illustrates the main limitation of the point sampling approach used by MSAA 4 and 8. The main problem is that there are many cases where 2 or more sampling points line up with the triangle edges. This reduces the number of transitions as edges move across pixels There are 2 extreme cases.
The two examples on the left side illustrate the best cases with horizontal (HE) and vertical (VE) edges at 0 degrees angle. In these cases, there are 4 (or 8) transitions as edges move across 4 (or 8) sample points.
The two examples on the right side illustrate the worst cases with edges at roughly 30 degrees angle. In these cases, there can be only 2 (or 3) transitions as edges move across 4 (or 8) sample points. The larger gaps between edge transitions can cause narrow face breakups for face narrower than ½ pixel wide.

By comparison, the number of transitions for ABAA is the same as the best case of MSAA. With ABAA, the number of transitions is independent of edge angles. With N subpixel areas, there are always N transitions with gaps of 1/N pixel wide. There are no narrow faces breakup for faces wider than 1/N pixel wide.

### 3. DESCRIPTION OF THE INVENTION

### Brief Description of the Drawings

FIG. 3A shows how the subpixels are defined with ABAA and MSAA.

FIG. 3B shows four solutions for subpixels mapping using ABAA

FIG. 3C shows the basic definition for triangle edges.

FIG. 3D shows two main types of extended edges: Vertical (VE) and Horizontal (HE) Edges, and how triangle extended edges intersect a tile boundary at RP.

FIG. 3E shows 8 cases if extended edge types

FIG. 3F shows edge cases according to VE, HE, BE and Slope Sign.

FIG. 3G shows 2 examples of tile intersected by Vertical Edge (VE) type

FIG. 3H shows 2 examples of tile intersected by Horizontal Edge (HE) type

FIG. 3I shows 2 examples of covered area computation for ABAA, for the trapezoids resulting from a pixel intersected by a VE and an HE.

FIG. 3J shows how the pixel covered area is computed for a VE

FIG. 3K illustrate the triangle rendering according to edge information.

FIG. 3L shows an example of span traversing with triangle edges.

### DESCRIPTION OF THE INVENTION

### Description of ABAA Implementation

Most approaches, like MSAA, rely on multiple subpixels point sampling to solve the aliasing problems in CGI. The main problems with MSAA are increased processing time and narrow faces breakup. The proposed approach, area-based anti-aliasing (ABAA) solves these problems and improve the image quality. It measures the area of a pixel that is partially covered by a face and assigns it to subpixel areas in that pixel to the nearest digit.

FIG. 3A illustrates how the definition of subpixels with ABAA differs from MSAA.

On the right side, the figure shows how 4 or 8 subpixel sample points can be assigned for MSAA, On the left side, the figure shows how 4 or 8 subpixel areas can be assigned for ABAA. In the case of ABAA, two possible sub-area subpixel mappings are shown for 4 and 8 subpixels area selection. There are many advantages of ABAA over MSAA. For color and texture, only one single point is required per pixel. For ABAA, the single sample point for the face color is at the center of the Pixel, instead of the top left corner as defined in many approaches.

This figure also shows the image as 2-dimensional array of pixels.

For the purpose of computations or description of examples, the pixels can be organized as square arrays of N×N pixels, referred to as tiles. The image can be decomposed into square tiles of any size and scaled to 1.0×1.0. Using 16-bit binary fixed-point numbers for coordinate for a 1 k×1 k image, this provides a resolution of 1/16 pixel. In this example a span is defined as a two-dimensional array of 8×8 pixels. This 8×8 span will be useful for describing examples.

FIG. 3B shows possible selections of subpixel areas far ABAA, depending on the number of subpixels and the way the subpixel areas align with the pixel boundaries. Two solutions are presented for 4 Subpixels, and 2 solutions for 8 subpixels. When the subpixels align with pixel corners, the ABAA solution is identified with the letter “X”. When subpixels are aligned with the middle of pixel sides, the solution is identified with the letter “O”. The solution for implementing the “ABAA-X” and “ABAA-O” mappings will vary slightly. The image quality for the “X” and “O” implementations should be comparable.

### Processing Triangle Edges

For the ABAA implementation, the definition of triangle edges is optimized in order to avoid the drawbacks of the basic edge definition. Using the edge representation using a vertex and a slope is inefficient.

The image rendering with triangle edges requires many repetitive operations. Edge slopes are repetitively used to compute edge intersections with pixels and scanlines boundaries. For tile traversing, edge slopes are used to jump from tile to tile. Any improvement in the processing steps result in direct improved system performance. Also, computation with fixed-point variables is more efficient than with floating-point variables. In order to achieve optimum performances, edge components can be defined in a 16-bit fixed-point format that achieves this goal.

With floating point computations, the floating-point format could handle very large slope values. In the case of true horizontal edges, a floating-point value near infinity could provide a good approximation. But it is not practical. Also, when using fixed point computations, a large number of digits are required for near horizontal edges.

The edge format can be modified to solve the problem with infinite slopes and to improve the efficiency of the edge traversing operation.

Problems with Basic Edge Definition

FIG. 3C shows the basic definition of triangle edges in the 2D plane. In this figure, there is a triangle with 3 vertices V0, V1 and V2. The segments connecting the vertices define 3 edges E0, E1, and E2. The (Xi, Yi) image coordinate system is aligned with the (Pix, SL) coordinates system. Since edges are processed in SL order, the variable y is the independent variable. On each SL, x is the dependent variable. So, in 2D the line function is x=g(y).

When processing the image, triangles are processed from top to bottom. So, y is the independent variable and x is the dependent variable.

The edge slope of a non-horizontal edge can be computed as:

$$Slp = dx / dy , when dy != 0.$$

According to this definition, a true vertical edge has a zero slope. There is a problem with true horizontal edges. Edges near the horizontal axis have a very large slope approaching infinity. In the worst case, the edge slope would reach infinity for true horizontal edges.

In general, a polygon edge is defined by 3 variables, where i=1, 2 or 3:
Starting vertex with 2 coordinate variables xi and yi: Vi=(xi, yi))
Edge Slope: Slpi=dxi/dyi, when dyi!=0

There are 2 disadvantages.
The slope size is unlimited and would reach infinity if the component dyi==0.
Beside the slope, 2 coordinate components (xi, yi) are required to position an edge.

As will be shown, edges can be positioned with only one component, x, or y.

### Optimized Edge Definition

For the description of the invention, a new edge description is introduced.

Edges are described using a 16-bit Extended Edge (EE) format that optimizes the edge traversing and image rendering operations. It provides many advantages over the basic edge definition, such as:
x, y and Slp use the same 16 bits EE format.
Limit the slope size to no greater than 1.0.
EEs are defined by only 2 components: Slp and a Reference Point (RP) on a tile boundary.
Provide symmetry in horizontal and vertical directions using vertical (VE) and horizontal (HE) edge types
Optimize the tile-to-tile and pixel-to pixel traversing operations.

### Triangle Parameters Defined Inside of Tiles

FIG. 3D shows an example of how the triangle EEs are defined within a tile boundary.

A triangle is defined inside of tile of size 1.0×1.0.

In this approach, the edge slope, Slp, use a fixed-point slope format similar to that of (x, y) coordinates. A 16-bit fixed-point format for edge slopes is suitable for an image of 1 k×1 k pixels and an accuracy of 1/16 pixel.

In this approach, the edge slope for HE and VE differs as follows:
Foe HE: Slp=dx/dy, |dx|<|dy|
For VE: Slp=dy/dx

There is a nice property when using a different edge slope type for HEs and VEs. The slope, Slp, is equal to the difference between the entry point and exit intersection points (RP) with tiles, since the size of tiles is 1.0. The value of Slp remains unchanged for all the tiles. The entry point and exit intersection points are referenced as follows:
Entry reference point: RP
Exit reference point: RP+Slp.

This 16-bit signed fixed-point edge format for x, y and Slp is:
sb.bbbbbbbbbb′bbbb, where ‘s’ represents the sign bit and ‘b’ represent a bit.

The two leading bits, ‘sb’, provides for an extended range of −1.0 to 2.0. The last 4 fractional bits ‘bbbb’ represent fractional pixel dimensions. They provide a subpixel accuracy of 1/16 pixel.

Note that for image sizes greater than 1 k×1 k, the EE format can be adjusted to more bits.

An important feature of EEs is that they are not limited to the edge segments between polygon vertices. They extend up to the boundaries of image tiles and spans of any size. Tiles are square image areas scaled to size 1.0×1.0. In the following a tile can scaled to any size, from the largest tile that contains the whole image up to an 8×8 pixel span.

In order to prevent RP from underflowing or overflowing, the range of their coordinates is extended from “0.0 to 1.0” inside of the tiles, to an extended range of “−1.0 to 2.0”.

### Edge Parameters and Flags

With the EE format, triangle edges are now defined with only 2 variables and some flags:
16 bits: EE x, or y, intersection coordinate (RP)
16 bits: EE Slp
Edge flag for slopes: VE Slp (|dx/dy|<1), or VE Slp (|dx/dy|=1), or HE Slp: (|dy/dx|<1)
Edge flag for slope sign: SlpSgn
Edge direction flag: BE vs !BE

The edge definition is the same for EEs inside of a tile, span or pixel. As can be seen from this figure, the Slp is equal to the difference between the EE entry point and the EE exit point.

A general Tile can be of size: 2**N×2**N Pixels

At the highest level, the tile is aa 1 k×1 k pixels canvas. In this case:
1 k×1 k Pixels=128×128 spans=16 k spans

When processing intersected pixels, edges are tested to determine the area that they cover. Basically, each edge divides the rendering area into two sides: the inside and the outside. On the outside the area is not covered by the triangle. On the inside, the area is covered by the triangle edge. Until all the edges are tested, the half of the inside area is potentially covered by the triangle.

When a triangle is processed in the 2D Geometric Processor, the order of triangle vertices has to be specified. The order can be clockwise like the movement of the hands on a clock, or counter-clockwise like the angle degrees in a circle.

### Vertex and Edge Sequences

In this document, the order of triangle vertices in 3D objects is counter-clockwise for the visible side of surfaces. For the back side of faces (not visible), the order is clockwise.

FIG. 3E shows how edges are organized into 2 main edge types. There are examples for 8 edge cases.
4 cases for vertical edges (VE), left (Lft), right (Rgt) and SlpSgn
4 cases for horizontal edges (HE), top (Top), bottom (Bot) and SlpSgn

FIG. 3F shows how edges are used to detect the subpixel area coverage in two directions:
For VE, the direction is left to right
For HE, the direction is top to bottom

### Beginning (BE) and Ending (!BE) Edges

Also, edges have to be defined as Beginning (BE) and Ending (!BE) edges. Edges are processed in counter clockwise direction. Depending on edge slope-size, they are organized into 2 main types: VE and HE. More precisely, depending on their direction they can be referred to as beginning (BE=1) or ending (BE=0) edges.
VE Lft (left), BE=1, Direction down, with dy>0
VE Rgt (right), BE=0, Direction top, with dy<0
HE Top (top), BE=1, Direction left, with dx<0
HE Bot (bottom), BE=0, Direction right, with dx>0

In FIGS. 3G and 3H, there are examples of extended edges for VE and HE, respectively. The arrow besides the triangle segment indicates the edge directions that determine between beginning edges (BE) and ending edges (!BE).

### Area Computation for ABAA Using Trapezoid.

ABAA relies on computing the area of pixels that are covered by triangular edges.

When a triangle intersects a pixel, the covered (inside) area can be easily evaluated by using the properties of trapezoid. When an edge intersects a pixel, it defines 2 trapezoids: an inside and an outside trapezoid.

There are 2 cases to be considered:
1. EE intersections with pixel boundaries within 0.0 and 1.0
2. EE intersections with pixel boundaries not within 0.0 and 1.0
   EE Intersections within 0.0 and 1.0

FIG. 3I shows examples with VE and HE edges, where the range of EE intersections with opposite boundaries of pixels is within 0.0 and 1.0. These examples with VE and HE are similar.

There is a ‘symmetry axis’ (Sym Axis) at equal distance of the Pix and SL axis. Because of this Extended-Edge symmetry with Pix and SL coordinates, it is not necessary to always analyze cases for both VE and HE. The HE cases are obtained from the VE cases using the VE and HE symmetry relative to the symmetry axis (Sym Axis).

Considering the left example with VE, the EE intersections with the top and bottom boundaries of the pixel divides the pixel into 2 trapezoidal areas. The area of each trapezoid is equal to its height multiplied by the average of its top and bottom width. The average width of the trapezoids can be easily measured on the horizontal midline (H-MidLn) that is at equal distance from its top and bottom boundaries. For VEs, the area of the trapezoids is determined as follows.

The VE intersects the trapezoid H-MidLn at RP. The intersection point, RP, divides the H-MidLn into 2 segments of distance d and 1−d insides of the pixel. Since the height of the trapezoids is 1.0, the area of the left trapezoid is d. The area of the right trapezoid is 1−d

Similarly, for the right-side figure the case with HE can be derived from the symmetry axis, using the vertical midline, V-MidLn.

The HE intersects the trapezoid V-MidLn at RP. The intersection point, RP, divides the V-MidLn into 2 segments of distance d and 1−d insides of the pixel. Since the height of the trapezoids is 1.0, the area of the top trapezoid is d. The area of the bottom trapezoid is 1−d

The pixel covered area depends on the BE flag.
For an ending edge, BE==0. The pixel covered area is d (before RP).
For a beginning edge, BE==1. The pixel covered area is 1−d (after RP).

Note that, when using 4 fractional bits of pixels, the subpixel resolution is 1/16. The maximum covered area computation error will be: e= 1/16

Note that the ABAA solution could also be implemented using the basic definition of edges, but at the cost of greatly reduced performances.

EE Intersections not within 0.0 and 1.0

In the 2^{nd} case, the EE intersections with opposite sides of pixels is not within 0.0 and 1.0. The EE intersections with opposite sides of pixel still define trapezoidal area, with a small triangle extending outside of the pixels. The area of the extended trapezoid is equal to the non-covered portion inside of the pixel. So, these 2 areas cancel each other.

FIG. 3J shows examples for VE intersecting inside and outside of pixel.

For EE with slope size up to 1.0, the maximum area outside of the pixel is ⅛. When 4 subpixel areas are used, the error is <⅛. So, it can be ignored.

When 8 subpixels are used, there are 2 cases, identified with the slope flags, S0 and S1.

S0 (Flag S=0), when the slope size is between 0.0 and 0.5. The max extended area is < 1/16. In this case, the whole pixel area is covered when the edge enters the pixel.

S1 (Flag S=1), when the slope size is between 0.5 and 1.0. The max extended area is <⅛. In this case, ⅞ of pixel area is covered when the edge enters the pixel. In this case, the distance of the computed area d still represents the area of the trapezoid.

### Example of Triangle Rendering

In FIG. 3K, a triangle inside of a span is rendered according to the parameters from 3 edges.

ABAA relies on computing the area of pixels that are covered by triangular edges.

In the 2D image each triangle edge divides the image area into an inside area (covered) and an outside area (not covered). The triangle area is defined by an AND function of the 3 covered areas defined by the 3 triangle edges.

In this example, the span area is defined by an array of 8×8 pixels. Each pixel area contains N subpixels. So, the span area consists of is 64*N subpixels.

The span area covered by the triangle is derived in 3 steps.

### Step1:

Identify the parameters of the 3 triangle edges.

In this example the 3 edges have the following flags: ‘HE Top’, ‘VE Lft’ and ‘VE Rgt’.

### Step2:

For each edge, evaluate the Span covered area. Set the covered subpixel state to ‘1’.

### Refer to Area0, Area1 and Area2.

For each edge, all the covered Subpixels are set to ‘1’ and the remaining Subpixels are set to ‘0’.

### Step3:

The area ‘TriArea’ covered by the triangle is obtained by doing the AND function of the covered subpixels in the 3 areas defined by intersecting edges. This AND operation on the 3 covered areas is performed bitwise on all 64*N subpixels inside of the 8×8 pixel span.

After Step 3, the area ‘TriArea’ inside of the span that is covered by the triangle is defined by the subpixels that are set to ‘1’.

### Span Traversing

FIG. 3L shows an example of span traversing with triangle edges. This example shows another approach to triangle rendering.

Here, the triangle can be processed by traversing the left and right edges of a triangle from top to bottom and rendering line by line, or span by span.

When the whole image is considered, the intersected spans can be identified within a rectangular area defined by the Min and Max values of the 3 vertices of the triangle to render. That is:
PixMin to PixMax
SLMin to SLMax.

In this example, the triangle is inside of a rendering area of 4×3 Spans. The pixel covered areas are obtained by using the 3 edges to traverse the pixels across these Span areas, identified with the grey dot “Edge Start RP”.

For VE, traverse the spans with left and right edges from top to bottom. The starting intersection point will be on the top side of the rendering area.

The start RPs of edges are shown with grey dots. When traversing the pixels, the reference points, RP, are at the intersection of edges with pixel midlines. In this figure, pixel V & H-MidLn are shown for the 1^{st} pixel of each span.

As edges traverse intersected pixels on the left and right side of the triangle, the scanline segments to display are defined between the two intersected pixels. The covered areas of the left and right pixels are measured at the pixel's RPs. The pixels within the area between the left and right intersected pixels (if any) are fully covered. For each line, the results are entered in the color buffer.

Note that in this example, the triangle bottom edge is an HE with negative slope. For HE with negative slope, traverse the spans from right to left.

If the triangle bottom edge was an HE with positive slope, traverse the spans from left to right.

The process continues until SLMax is reached.

### Comparison of ABAA Vs MSAA

The area-based approach used by ABAA solves several problems encountered with SSAA and MSAA.
Using 2 types of edges, HE and VE, ABAA can easily identify an intersected pixel when an edge crosses a midline inside of that pixel, at the intersection reference point RP.
It can quickly determine the covered area in an intersected pixel and accurately compute the mixed color.
It produces equal steps as triangle edges move across pixels, for all edge-orientations. The covered area of pixels increases uniformly (linearly) from 0.0 to 1.0 as edges move across pixels.
With 4 (or 8) subpixels, it can handle narrow face breakup for faces wider than ¼ (or ⅛) pixel wide.
It can produce high image quality without speed penalty. It is faster since is does not require multiple frame processing.

Another advantage of ABAA over MSAA, is that all the subpixels cover an equal area inside of a pixel. For intersected pixels, the measured covered area is mapped into subpixel areas according to the pixel map, using the distance d, the edge flags. Using this approach, as a polygon edge moves across an intersected pixel, the area increments are uniform, regardless of the edge orientation. This not true for the SSAA and MSAA approaches.

The ABAA method is described in more details in books of M. A Rohner. [1], [2], [3].

### Color and Texture Sample Point

For color and texture, only one sample point at the center of the pixel is needed. There could be gradient overflow problems with thin faces. Color, texture and Z gradients could overflow for narrow faces that are inside of pixels but do not include the pixel center. Narrow faces can have large color and texture gradients. For this reason, the gradients must be clamped for narrow faces to avoid gradients overflow. There is example such solution in the following patent:

### Method and Apparatus for Clamping Image Gradients [4]

U.S. Pat. No. 6,184,887B1 Michel A. Rohner, Oak Technology, Inc.

### Sample Points for Z Distance

In order to detect the subpixel visibility, the subpixels distances from overlapping triangles need to be compared. For this purpose, a Z-distance can be assigned inside of each subpixel area. When processing very narrow faces, the Z-gradients could overflow. The Z-gradients should be clamped using the same approach as used for color and texture. The subpixel sample points should be selected inside of the subpixel areas, using solutions to the 8-queens puzzle.

### 4. DETAILED IMPLEMENTATION OF THE ABAA METHOD

### Brief Description of the Drawings

FIG. 4A shows the flow chart for gextracting the edge parameters.

FIG. 4B shows two examples of edge intersection with pixel midline at RP with a VE for ABAA4 and an HE for ABAA8

FIG. 4C shows the pixel-map with subpixel sequences for the 4 edge cases using ABAA4-X

FIG. 4D shows the flow chart that decodes the subpixel mapping, using ABAA4-X.

FIG. 4E shows four cases of edge moving across 4 subpixel areas, using ABAA4-X.

FIG. 4F shows the pixel-map with subpixel sequences for the 4 edge cases, using ABAA4-O

FIG. 4G shows the flow chart that decodes the subpixel mapping, using ABAA4-O.

FIG. 4H shows four cases of edge moving across 4 subpixel areas, using ABAA4-O.

FIG. 4I shows the pixel-map with subpixel sequences for the 8 edge cases, using ABAA8-X

FIG. 4J shows the flow chart that decodes the subpixel mapping, using ABAA8-X.

FIG. 4K shows 4 cases of edge with |Slp|<0.5 moving across 8 subpixel areas, using ABAA8-X.

FIG. 4L shows 4 cases of edge with |Slp|>0.5 moving across 8 subpixel areas, using ABAA8-X.

FIG. 4M shows the pixel-map with subpixel sequences for the 8 edge cases, using ABAA8-O

FIG. 4N shows the flow chart that decodes the subpixel mapping, using ABAA8-O.

FIG. 4O shows 4 cases of edge with |Slp|<0.5 moving across 8 subpixel areas, using ABAA8-O.

FIG. 4P shows 4 cases of edge with |Slp|>0.5 moving across 8 subpixel areas, using ABAA8-O.

FIG. 4Q shows four quadrants of pixel with VE and HE symmetry.

FIG. 4R shows 2 pixels divided into 4 quadrants of 4 or 8 subpixels Each. This results in 16 and 32 subpixels per pixel respectively.

### DETAILED IMPLEMENTATION OF THE ABAA METHOD

For the practical implementation of the invention, the process can be described with decoding tables inside pixel-maps or in flowcharts. These flowcharts provide for flexible implementation in HW or SW. The design can be implemented using a C-program for a SW implementation, or using a Verilog RTL program for a HW implementation. It also can be a mix of HW and SW using RTL and GPU implementations.

### Edge Parameter Detection Flowchart

In FIG. 4A, there is a flow chart that shows how to extract the edge parameters for a HW or a SW implementation. It shows how to decode the edge parameters and flags.

### Slope Flags

The slope flags S0 and S1 are derived from the 3 most significant bits (MSBs) of the edge slope. This flag is needed to decide between 2 cases of slopes with 8 subpixels, as will be shown later on.

Note, that it is not necessary to indicate greater or equal (>=), since the slopes are truncated fixed point numbers, where the truncated portion is unknown. For this reason, the ‘>’ symbol will be used to indicate ‘>=’.

For a 1 k×1 k pixels image, a 16-bit signed fixed-point edge format is sufficient for xi, yi and Slp.
sb.bbbbbbbbbb′bbbb, where ‘s’ represents the sign bit and ‘b’ represent a bit.

The binary format for the slope inside of a pixel is: Slp=s.bbbb.

Slp can be expressed in decimal or binary notation.
Decimal notation: −1.0<S1<−0.5<S0<0.0<S0<0.5<S1<1.0
Binary notation: (1)1.0000<S1<1.1000<S0<0.0000<S0<0.1000<S1<(0)1.0000

As a consequence, since the magnitude of the slopes cannot be greater than 1.0, the operations with triangle edges can be performed with fixed-points (instead of floating point). Another advantage is that for true horizontal edges the slope is 0.0, instead of infinity.

### Processing Edge Intersecting a Pixel

ABAA can be implemented directly using the pixel covered areas, or the area can be mapped into 4, 8, 16 or 32 subpixel areas.

In FIG. 4B, there are two examples of a pixel intersected by two types of triangle edge: VE and HE
ABAA 4: Pixel with 4 subpixel areas intersected by a VE.
RP is defined as the intersection of the VE with the H-MidLn.
ABAA 8: Pixel with 8 subpixel areas intersected by an HE.
RP is defined as the intersection of the HE with the V-MidLn.

ABAA detects the intersected pixel at RP and evaluates the partially covered area inside of these pixels in one step.

When a pixel is intersected by a triangle edge, that edge divides the pixel into 2 trapezoids. Since the height of the trapezoid is 1.0, the areas of these trapezoids are equal to the average of their top width and bottom width. These areas can be measured on the pixel midline, that is half-way from the top and bottom of the trapezoid. The intersecting edge are beginning edges. So, the covered area is on the right side for VE and the bottom side for HE.

In the top example with 4 subpixels, a VE intersects the H-MidLn at RP. The covered area is measured on the H-MidLn.

In the bottom example with 8 subpixels, an HE intersects the V-MidLn at RP. The covered area is measured on the V-MidLn.

With ABAA, a pixel is considered intersected only when the edge intersects the midline inside of that pixel. It does not matter if the trapezoid extends partially into an adjacent pixel. It does not matter if the edge intersects a pixel near a corner without intersecting a midline.

Note that even when the trapezoid extends outside the pixel boundary, the measured area is still correct. As edges move across pixels, the covered area transitions from non-covered to fully covered in equal steps, from 0.0 to 1.0. This method is very accurate. With 4 fractional bits, there can be 16 equal steps. The pixel color of intersected pixels is a weighted mix according to the 2 areas.

There can be 2 approaches when implementing ABAA:
1. Use the measured areas to mix the colors of the 2 partial areas in the pixel. This approach works well when there are only 2 fragments in a pixel. When there are more fragments, this approach produces acceptable results.
2. Assign the area covered by edges into subpixel areas (4, 6, 16 or 32). This approach is better at handling cases when there are more than 2 fragments in a pixel. The mapping of the pixel covered area into subpixel areas is described below.

Ther are 2 ways to computes the color mix. The color mix can be calculated either by using the partially covered area, or by using the covered subpixel counts.

Note that when there are more than 2 intersections per pixel, the implementation should use two Z buffers to save the Z, Color and covered subpixels of the top 2 faces. In most case, the mix of the top 2 faces should produce good results.

ABAA Solution with 4 Subpixels

Two flags, VE and Pos, will determine four subpixel sequences (or CodeBits) as edges enter the pixel area. The 3rd flag, BE, determine on which side of the edge the subpixels are covered.

For the 4-subpixels solution, 2 implementations are presented: ABAA4-X and ABAA4-0. There are 4 main cases according to”
Edge orientation Flag: VE vs HE
Edge slope polarity Flag: Pos vs Neg

The edge beginning or ending flag, BE, define these 4 cases for beginning edges when BE==1.

For ending edges, when BE==0, the complement cases are defined by inversing the Codebits

In FIG. 4C, the four cases are summarized in a pixel-map for ABAA4-X. The 4 subpixel sequences are identified with their flags and corresponding distances d0, d1, d2 and d3. This figure shows the transitions when the subpixels are turned on for beginning edges (BE=1). For ending edges (BE=0) the sequence indicates when the subpixels are turned off.

In order to classify the subpixel area assignments, the 4 subpixel areas can be identified as “ABAA4-X. The “X” symbol indicates that the 4 subpixels area are near the 4 corners of the pixel.

In FIG. 4D, a flow chart shows the same information for ABAA4-X. The decoding for the subpixel sequences (CodeBits) is described in that flow chart. The subpixel sequences can be stored in a local table in a local memory or other storage.

In FIG. 4E, there are sequences of edges crossing 4 subpixel areas for the 4 edge cases, using ABAA4-X. When edges intersect the midline in the same quarter of distance d, the same number of subpixels is covered

In the next 3 figures, there is another solution for 4 subpixels, denoted as ABBA4-O. The four cases are summarized, including the subpixel sequences.

In FIG. 4F, there is the pixel-map with subpixel sequences for 4 edge cases using ABAA4-O.

In FIG. 4G, there is the flow chart that shows the decoding for 4 edge cases using ABAA4-O.

FIG. 4H shows 4 cases of edge moving across 4 subpixels, using ABAA4-O.

ABAA Solution with 8 Subpixels

For the 8-subpixels solution, there are 3 edge flags to consider. A 4^{th} flag, BE, is used to identify the covered side of edges.
Edge orientation Flag: VE vs HE
Edge Polarity Flag: Pos vs Neg
Slope size Flag: S1
Esge beginning vs ending flag: BE vs !BE.

There are 4 figures for each case of ABAA8-X and ABAA8-O.
pixel-map with edge decoding and subpixel sequences.
flow chart with edge decoding and subpixel sequences.
2 figures with examples for flags S0 and S1
In these 2 figures, 4 cases of edge moving across a pixel are presented for flags S0 and S1. In each of the 4 cases, the 8-subpixels sequence is illustrated for a BE edge moving across a pixel.

The following four figures show the decoding for ABAA8-X, and examples of edges moving across a pixel.

In FIG. 4I, there is the pixel-map with subpixel sequences for 8 edge cases, using ABAA8-X.

In FIG. 4J, there is the flow chart that shows the decoding for 8 edge cases, using ABAA8-X.

FIG. 4K shows 4 cases of edge moving across 8 subpixels (S0: |Slp|<0.5), using ABAA8-X.

FIG. 4L shows 4 cases of edge moving across 8 subpixels (S1: |Slp|>0.5), using ABAA8-X.

The following four figures show the decoding for ABAA8-0, and examples of edges moving across a pixel.

In FIG. 4M, there is the pixel-map with subpixel sequences for 8 edge cases, using ABAA8-O.

In FIG. 4N, there is the flow chart that shows the decoding for 8 edge cases, using ABAA8-O.

FIG. 4O shows 4 cases of edge moving across 8 subpixels (S0: |Slp|<0.5), using ABAA8-O.

FIG. 4P shows 4 cases of edge moving across 8 subpixels (S1: | Slp|>0.5), using ABAA8-O

In the pixel-maps and flow charts, there are 8 sequences depending on 3 Edge Flags.

The first tested flag is VE vs HE. The next tested flag is the edge polarity according to the slope sign: Slp<0 and Slp>0.

Finally, the subpixel sequences are decoded according to the slope size flag (S0 or S1) and the edge distances (d0, d1, d2 and d3) from the pixel boundary along the midline.

The subpixel sequences are presented for beginning edges, that is BE==1. For ending edges (BE=0) the sequence indicates when the subpixels are turned off.

The fourth tested flag is the beginning or ending edge flag (BE or !BE). For ending edges, the subpixel active flags (CodeBits) in the table have to be inverted.

### Determine Covered Subpixel Areas in One HW Cycle

Given a pixel intersected by a triangle (or polygon) edge, the covered subpixel areas are obtained with only one distance measurement, d, on the intersection of that edge with the pixel midline. This operation is similar for VE and HE edges. This operation can be performed in HW or SW for 4 or 8 subpixels using the pixel-map or the subpixel decoding flowchart. The 4-bits of intersection of the edge with the midline determine which subpixel areas are covered. This operation can be performed in HW in one cycle.

### Pixel-to-Pixel and Span-to-Span Traversing

When considering the whole image, edges are defined with a slope, Slp, and a reference point, RP, on a tile boundary. When doing span to span or pixel to pixel traversing, the reference point, RP, should be moved to a pixel midline by adding half the pixel slope to RP. For example:
For a span, d0=RP+Slp/16.
For a pixel, d0=RP+Slp/2.

Using the intersection d0 of a triangle edge with the pixel midline, the intersection d1 of the edge with the next pixel midline is obtained in one step by adding the slope, Slp.

$$d 1 = d 0 + Slp$$

Given an 8-pixel span, add the slope 8 times to get the intersection with the next span.

$$d 8 = d 0 + 8 * Slp$$

$$// 3 left - shift of Slp , result for next span$$

This operation can be done sequentially in SW (or iteratively in HW) using a do-loop:

$$d ( i ) = d 0 ; \qquad // define starting value$$

$$for \begin{matrix}( i = 0 ; i = 8 ; ++ i ) d ( i + 1 ) = d ( i ) + Slp ; & // d ( 8 ) is the start of next span\end{matrix}$$

This operation can be done in one cycle in HW, using a 3-levels 8-adders-tree, starting at d(0)=d0.

$$d 1 = d 0 + Slp ; \qquad // {1}^{st} level$$

$$d 2 = d 0 + 2 * Slp ; \qquad // 2 nd level , 1 left - shift of Slp$$

$$d 3 = d 2 + Slp ; \qquad // 3 r d level$$

$$d 4 = d 0 + 4 * Slp \qquad // {1}^{st} level , 2 left - shift of Slp$$

$$d 5 = d 4 + Slp ; \qquad // 2 nd level$$

$$d 6 = d 4 + 2 * Slp ; \qquad // 2 nd level , 1 left - shift of Slp$$

$$d 7 = d 6 + Slp ; \qquad // 3 r d level$$

$$d 8 = d 0 + 8 * Slp ; \qquad // {1}^{st} level , 3 left - shift of Slp , result for next span$$

Using this approach, the number of covered subpixels in 8 consecutive pixels can be derived in 8 iterative cycles or only one cycle in HW using an adders-tree. As can be seen this approach using the ABAA solution is extremely fast compared to the MSAA or SSAA approaches.

Note than when adding slopes of VE, the pixel number can change. If distance becomes negative, decrement the pixel number. If the distance becomes>1.0, increment the pixel number, di.

For HE with for negative slopes, traverse from right to left and subtract the slopes. For positive slopes, traverse the pixels from left to right. Eventually, when di is not within 0.0 and 1.0, the SL number could be incremented by 1.

### Processing Triangle

In order to process a whole triangle, the 3 edges need to be processed, then the subpixel areas are ANDed to get the final triangle coverage. Refer to the example in SIMULATION section.

ABAA Implementation with 16 and 32 Subpixels

For 16 and 32 subpixels, the ABAA solution for 4 and 8 subpixels can be expanded by dividing pixels into 4 quadrants.

### Refer to FIG. 4Q.

For VEs, there are 2 rows of 2 quadrants. For HEs, there are 2 columns of 2 quadrants. The intersections with the quadrant midline provide with 2 measurements.

There is complete symmetry between VEs and HEs. So, some of the details will be described for VEs only. For HEs, the figures are obtained by using the symmetry around the 45-degree axis (Sym Axis).

For a beginning vertical edge (VE, BE) intersecting a midline, the quadrant on the left side is not covered and the quadrant on the right side is covered. For a beginning horizontal edge (HE, BE), the quadrant on the top side is not covered and the quadrant on the bottom side is covered.

When the midline in a quadrant is intersected by an edge, the ABAA method for 4 or 8 subpixels detection can be applied inside of that quadrant to detect the covered subpixels. The covered subpixels inside a quadrant need to be detected only when the midline of that quadrant is intersected.

FIG. 4R shows how the number of subpixel areas can be extended to 16 and 32 subpixels.

With 4 quadrants having each 4 subpixels, the total is 16 subpixels per pixel.

With 4 quadrants having each 8 subpixels, the total is 32 subpixels per pixel.

Note that the subpixels are numbered with hexadecimal numbering. This is to emphasize that at this level, the implementation deals with binary numbers. Also, for 32 subpixels, the leading 1 indicates the second row of quadrants.

### 5. SIMULATION

### Brief Description of the Drawings

FIG. 5A shows the selection of printing characters for ABAA and MSAA with 4 subpixels

FIG. 5B shows the selection of printing characters for ABAA and MSAA with 8 subpixels

FIG. 5C shows the C-program simulation of two triangle edges E0 and E1

FIG. 5D shows the C-program simulation of edge E2 and final triangle.

FIG. 5E shows a fan of eight thin faces processed with ABAA 4 and MSAA 4.

FIG. 5F shows the simulation results of 4 fan cases processed with ABAA 4 and MSAA 4.

FIG. 5G shows a fan of eight thin faces processed with ABAA 8 and MSAA 8.

FIG. 5H shows the simulation results of 4 fan cases processed with ABAA 8 and MSAA 8.

### Results of the Simulation Program

Results of Simulation Displayed with ASCII Characters

Several cases have been simulated with a C-program. The program output consists of arrays of char. The simulation program output consists of an 8×8 pixels span-grids, on which the subpixels are displayed using ASCII text characters. This provides an easy and clear way to display the results and provide valuable information into this document.

First, in order to make the displayed pixels square, an array of 6×3 chars is used for each pixel. The first char on each row and between each pixel is the “|” char to show pixel boundaries. On the 3^{rd} row, the underline “_” char is used to show the pixel lower boundaries.

Then, an 8×8 pixel span can be stored in a 48×24 (8*(6×3)) characters array. Also, 3 rows are added on top and 6 chars are added on the right side of the span to show the pixel and the scanline numbers.

The covered subpixels are shown with a ‘*’ character, or a face number.

The non-covered subpixels are shown with a ‘.’ (period) character.

The subpixels within a pixel need to be defined for ABAA4, MSAA4, ABAA8 and MSAA8.

FIG. 5A shows the selection of printing characters for ABAA and MSAA with 4 subpixels

FIG. 5B shows the selection of printing characters for ABAA and MSAA with 8 subpixels

A similar approach is used in the 5 examples to show how triangles are processed inside an 8×8 pixel span.

The first example shows how a triangle is processed inside of an 8×8 pixel span.

Then there are four examples to compare the processing 8 thin triangles with ABAA and MSAA, using 4 and 8 subpixels.

### Example 1: Triangle Processed with ABAA4

In the 1^{st} example, a triangle inside of an 8×8 pixel span is processed with ABAA 4.

FIG. 5C shows how the first 2 edges of a triangle are processed with ABAA4.

FIG. 5D shows how the 2rd edges of a triangle is processed with ABAA4 and how the final triangle is obtained by ANDing the results from the 3 edges.

The two Figures display the results of processing the 3 triangle edges and the final triangle. The triangle is processed in 3 steps:
Step 1: Identify the 3 triangle edges with their parameters and flags: E0, E1 and E2.
Step 2: Determine the covered area for each edge, by identifying each covered subpixel.
Step 3: Obtain the triangle covered area by ANDing the covered subpixels from the 3 edges.
   Examples of Thin Triangles Processed with ABAA and MSAA

In the other examples, fans made of 8 thin triangles are processed with both ABAA and MSAA

The advantage of ABAA over MSAA is more noticeable for faces narrower than ½ pixel wide. For the comparison between ABAA and MSAA, several cases are simulated. Each test case consists of 8 thin triangles of size 8×1 pixels organized as a 90 degree fan inside of an 8×8 pixel span. Each triangle has a height of 8 pixels and a base of 1 pixel. Each triangle height can be divided into 8 slices 1 pixel thick. From these 8 slices, there are 8 cases of narrow width between 1/16 to 15/16 pixel. It will be shown that ABAA produces the best images.

In the first figure, the same test with a fan of 8 thin triangles is processed with both ABAA4 and MSAA4.

Then the result of four similar test cases consisting of 8 thin triangles with different orientation are simulated and summarized. The first case is repeated, followed by 3 other test cases. These test cases are first simulated with ABAA4 and MSAA4, then simulated with ABAA8 and MSAA8.

When printed, images with gray shades can be easier to evaluate at first. But, because of the limitation of the printing process, the results can be inconclusive. Instead of gray shades, in each triangle the covered Subpixels are identified with one of the 8 faces identifier, from, ‘a’ to ‘h’. The results consisting of the number of covered subpixels for each ⅛-pixel slices are tabulated in summary tables, beside the fans. In the summary tables, the covered subpixels inside slices of the thin triangles should show with incremental counts per pixel or per scanline. So, it should be easy to evaluate and compare the ABAA vs MSAA approaches.

### Examples 2 to 5: Comparison of ABAA Vs MSAA with Fans of 8 Thin Triangles

In the next examples the results of processing thin triangles with ABAA and MSAA with 4 and 8 subpixels are compared. The test cases consist of 8 thin triangles organized as a fan displayed inside of an 8×8 pixel-span. In each fan, there are four 8-scanline long triangles (a, b, c & d) with vertical edges (VE), and four 8-pixel long triangles (e, f, g & h) with horizontal edges (HE). The triangle bases are 1-pixel wide.

The results are shown in summary tables. A similar test is repeated 3 times. The results of 4 tests are shown only in summary tables.

### Example 2: Fan of 8 Thin Triangles Processed with ABAA4 and MSAA4

In FIG. 5E, the fan has 8 triangles with positive slopes. The result for Pos Edges A is shown for ABAA4-X and MSAA4. Since the triangle tops are 0-pixel wide and the triangle bottoms are 1-pixel wide, the number of subpixels increments per pixel from top to bottom of triangle is expected to be ⅛ pixel. In the case of 4 subpixels, there should be 8 increments of ½ subpixel. Each number of subpixels should be repeated so that the triangle width is near 0 at the top and near 4 subpixels at the base, after 7 half subpixel increments. On the right side of the figures, there are 2 small tables showing the number of covered subpixels.

### Example 3: Four Fan Cases Processed with ABAA4 and MSAA4

In FIG. 5F, four cases of 8 thin triangle fans have been selected: 2 cases with positive slopes and 2 cases with negative slopes. Since there are gaps between the 8 triangles, the tests are organized into 2 sets A (even triangles) and B (odd triangles). In set A, there are 8 thin triangles with edges ranging from 0 to 90 degrees. In set B, there are also 8 thin triangles consisting of the gaps between the triangles of set A. Also, there are mirror cases from Pos to Neg Edges. In all, there are 4 test cases.

Results: Cases of 4 Fans Processed with 4 Subpixels

Using 4 subpixels for AA, four cases of thin triangle fans within an 8×8 pixels span have been simulated. The results are shown in 8 small tables, 4 for ABAA4 and 4 for MSAA4. They cover a wide range of cases with Even (A) and Odd (B) triangles. The cases are also mirrored from Pos to Neg edges. The results are shown with small tables only.
ABAA4 vs MSAA4 for Pos Edges A
ABAA4 vs MSAA4 for Pos Edges B
ABAA4 vs MSAA4 for Neg Edges A
ABAA4 vs MSAA4 for Neg Edges B

### Results for ABAA4

With ABAA, in most cases the increments consist of equal steps:
0, 0, 1, 1, 2, 2, 3, 3, or
0, 1, 1, 2, 2, 3, 3, 4, or
1, 1,2,2,3,3,4, 4

### Results for MSAA4

For MSAA4, some triangles are smoothly rendered, others are not, depending on the edge orientation.

Some Good: For MSAA4, the increments are similar to ABAA4, when the triangles edges are near Vertical (face a) or near Horizontal (face h). This is because the subpixels are positioned according to a solution to the 4-Rooks puzzle.

Some Bad: For other edge orientations, the increments are not constants. There are many increments of 2. There is also ‘hesitation’, when there are some steps with decrements (reverse count).

### Example 4: Fan of 8 Thin Triangles Processed with ABAA8 and MSAA8

The same test are repeated for ABAA8 and MSAA8

In FIG. 5G, the fan has 8 triangles with positive slopes. The fan example for ABAA8 vs MSAA8 for Pos Edges A is shown. For 8 subpixels, the incremental steps should be 1 subpixel each, that is ⅛ pixel. The results here are similar to the results in the examples with 4 subpixels.

### Example 5: Four Fan Cases Processed with ABAA8 and MSAA8

In FIG. 5H, four cases with 8 thin triangle fans have been selected: 2 cases with positive slopes and 2 cases with negative slopes.
ABAA8 vs MSAA8 for Pos Edges A
ABAA8 vs MSAA8 for Pos Edges B
ABAA8 vs MSAA8 for Neg Edges A
ABAA8 vs MSAA8 for Neg Edges B

For each of the 4 cases, 8 thin triangles are organized in a fan-array. The pairs of left and right edges are the same as in the example with 4 subpixels. In each fan, four triangles have vertical edges (a, b, c & d with VE) and four triangles have horizontal edges (e, f, g & h with HE).

Results: Cases of 4 Fans Processed with 8 Subpixels

Using 8 subpixels for AA, four cases of thin triangle fans within an 8×8 pixels span have been simulated. The results are summarized in 8 small tables: 4 for ABAA8 and 4 for MSAA8.

### Results for ABAA8

For ABAA8, in most cases, the increments are:
0, 1, 2, 3, 4, 5, 6, 7, or
1, 2, 3, 4, 5, 6, 7, 8

### Results for MSAA8

Some Good: For MSAA8, the increments are similar to ABAA8 when the triangles edges are near Vertical (face a) or near Horizontal (face h). This is because the subpixels are positioned according to a solution to the 8-Queens puzzle.
Some Bad: For other orientations, the increments are not constant, with many increments of 2.

There is also ‘hesitation’, when there are some steps with decrements

### 6. CONCLUSION

While various embodiments of the present invention have been described above, it should be understood that they have been presented by way of examples only, and not limitations. Thus, the breath and scope of the present invention should not be limited by any of the exemplary embodiments, but should be defined only in accordance with the following claims and their equivalents.

What is claimed is:

1. A simple and efficient method and embodiment for image rendering with anti-aliasing in computer graphics systems, whenever one or more edges from projected triangles (or polygons) intersect image pixels.

2. The method of claim 1, wherein pixels are divided into N subpixel areas of equal size, such as N is preferably 4 or 8 subpixels, and said subpixels are assigned a location on the pixel area according to a pixel-map, such as the pixel-map depends on the number of subpixels and the particular implementation.

3. The method of claim 2, wherein triangle edges use an extended edge (EE) format, optimized for detecting intersected pixels and measuring pixel covered area, with the following characteristics:
two edge types according to edge orientation flag (vertical edge, VE, vs horizontal, edge HE);
fixed point slope, Slp, that depends on edge orientation and with size no greater than 1.0;
fixed point reference point RP;
slope sign flag, SlpSgn;
slope direction flag (BE vs !BE);
Slope Size flag, when |Slp|>0.5 (S1 vs S0).

4. The method of claim 3, wherein a pixel intersected by triangle EE defines 2 trapezoids, and a midline is defined to be at equal distance between the top and bottom boundaries of the said trapezoids.

5. The method of claim 4, wherein pixels are declared as intersected only when the intersecting edge crosses the midline inside of said pixel at pixel reference point RP, such as RP divides the midline into 2 segment of sizes d and 1−d, where RP=d measures the EE position in the pixel, which is also the area of the 1^{st} trapezoid.

6. The method of claim 5, wherein RP on pixel midlines can be used for edge traversing from pixel-to-pixel by adding Slp to RP, such as NextRP=RP+Slp, or edge traversing from span-to-span by adding 8*Slp to RP, such as NextRP=RP+8*Slp.

7. The method of claim 5, wherein several embodiments can be implemented according to edge characteristics using a ‘pixel-map with subpixel sequences’ or a ‘flow chart’.

8. The method of claim 7, wherein two pixel-map solutions are provided for each N=4 and N=8 subpixels, depending on how the subpixels line up with pixel boundaries.

9. The method of claim 8, wherein the method can be extended to 16 and 32 subpixels by dividing pixels into 4 quadrants.

10. The method of claim 9, wherein the pixel color transitions from not-covered to full-covered results into N equal steps as an edge move across that pixel.

11. The method of claim 10, wherein the subpixel areas covered by polygon are obtained by ANDing the covered subpixels areas from all polygon edges.

12. The method of claim 11, wherein the pixel color is determined according to 2 cases:
completely covered pixels inherit the triangle color sampled at the center of that pixel;
intersected pixels use as pixel color the weighted-average of the covered subpixel colors, sampled at the center of the pixel.

13. The method of claim 12, wherein the Z-depth at the pixel center can be used for occulting.

14. The method of claim 13, wherein the Z depth can be computed at the center of the subpixel areas to solve the cases of penetration between faces inside of the pixel.

15. The method of claim 14, wherein in order to avoid overflow of color, texture and Z gradients, these gradients might require clamping for thin faces.

16. The method of claim 15, wherein the solutions can be implemented in HW or SW.

17. The method of claim 16, wherein computer simulation has shown that the quality of the described method, using subpixel areas, is simpler and superior to the point sample methods.
